(19) United States
(12) Patent Application Publication
(10) Pub. No.: US 2021/0056559 A1
(43) Pub. Date: Feb. 25, 2021

(54) DIGITAL DEVICE WARRANTY METHOD AND DEVICES

(71) Applicant: Eli Altaras, Irvine, CA (US)

(72) Inventor: Eli Altaras, Irvine, CA (US)

(21) Appl. No.: 16/830,337

(22) Filed: Mar. 26, 2020

Related U.S. Application Data
(63) Continuation-in-part of application No. 16/550,215, filed on Aug. 24, 2019.

(51) Int. Cl. G06Q 30/00; H04M 1/18

(52) U.S. Cl. CPC G06Q 30/012; H04M 1/185; G06Q 30/018

(57) ABSTRACT

The embodiments disclose a method including creating at least one warranty plan for financially protecting a phone or any digital device owner from damage of a phone case, screen protector, phone screen protector and a phone device or any digital device for any components damaged, providing warranty coverage for different types of phone cases including non-foldable and foldable phone cases, providing warranty coverage for different types of phone case screen protectors, providing warranty coverage for different types of phone or digital device components, registering warranty purchasers on a digital device warranty platform using a digital device warranty application, and receiving, recording and processing warranty claims filed by warranty coverage purchasers on the digital device warranty platform.

### CROSS-REFERENCE TO RELATED APPLICATIONS

This continuation-in-part application is based on pending U.S. Non-Provisional patent application Ser. No. 16/550,215 filed Aug. 24, 2019, entitled “DIGITAL DEVICE PROTECTIVE CASE METHOD AND DEVICE”, by Eli Altaras.

### BACKGROUND

Phones and other electronic devices are getting more expensive. Digital electronic technology is increasing and are adding more glass and sensitive parts and are becoming more susceptible to damage and more and more expensive to fix. Phones and other electronic devices sales are climbing and the consumers are paying more and therefore phones and other electronic devices pricing is more expensive. What is needed is a protection system in place to help protect the consumers from large financial losses if the phone or other electronic device is dropped and damaged.

### BRIEF DESCRIPTION OF THE DRAWINGS

FIG. 1 shows a block diagram of an overview of a digital device protective case method and device of one embodiment.

FIG. 2 shows for illustrative purposes only an example of a digital device protective case of one embodiment.

FIG. 3 shows for illustrative purposes only an example of a digital device protective case longitudinal cross section of one embodiment.

FIG. 4A shows a block diagram of an overview of digital device protective case bumper/sides pockets of one embodiment.

FIG. 4B shows for illustrative purposes only an example of case bumper/sides pockets of one embodiment.

FIG. 4C shows for illustrative purposes only an example of corner case bumper pockets of one embodiment.

FIG. 4D shows for illustrative purposes only an example of case bumper/sides pockets of one embodiment.

FIG. 5A shows for illustrative purposes only an example of a full cross section of case bumper/sides pocket of one embodiment.

FIG. 5B shows for illustrative purposes only an example of a tempered glass retain channel of one embodiment.

FIG. 6 shows for illustrative purposes only an example of a USB plug with digital and recharging features of one embodiment.

FIG. 7A shows a block diagram of an overview of integrating external universal fingerprint thermal recognition system of one embodiment.

FIG. 7B shows for illustrative purposes only an example of external universal fingerprint thermal imprint pad of one embodiment.

FIG. 8A shows a block diagram of an overview of integrating case external universal flexible photo/light power converters of one embodiment.

FIG. 8B shows for illustrative purposes only an example of case external universal solar recharger of one embodiment.

FIG. 9A shows a block diagram of an overview of integrating case external universal energy induction coils of one embodiment.

FIG. 9B shows for illustrative purposes only an example of case external universal energy induction coils recharger of one embodiment.

FIG. 10A shows for illustrative purposes only an example of a case external universal energy induction coils recharging pad of one embodiment.

FIG. 10B shows for illustrative purposes only an example of a case external universal energy induction coils recharging pad array of one embodiment.

FIG. 11A shows for illustrative purposes only an example of case with glue ledge of one embodiment.

FIG. 11B shows for illustrative purposes only an example of case with solid rubber glue platform of one embodiment.

FIG. 11C shows for illustrative purposes only an example of digital device protective case with glued tempered glass back of one embodiment.

FIG. 12A shows for illustrative purposes only an example of installing a tempered glass front cover of one embodiment.

FIG. 12B shows for illustrative purposes only an example of installing a tempered glass back cover of one embodiment.

FIG. 13A shows for illustrative purposes only an example of a printed tempered glass front cover of one embodiment.

FIG. 13B shows for illustrative purposes only an example of a printed tempered glass back cover of one embodiment.

FIG. 14A shows for illustrative purposes only an example of a profile view of a digital device protective case with slip and snap tempered glass cover installation features of one embodiment.

FIG. 14B shows for illustrative purposes only an example of a top view of a digital device protective case with slip and snap tempered glass cover installation features of one embodiment.

FIG. 14C shows for illustrative purposes only an example of slipping a tempered glass cover into a slip and snap tempered glass cover slot installation feature of one embodiment.

FIG. 14D shows for illustrative purposes only an example of a flexible slip and snap tempered glass cover installation feature pushed toward a cell phone glass surface of one embodiment.

FIG. 14E shows for illustrative purposes only an example of a flexible slip and snap tempered glass cover installation feature continuing a push toward a cell phone glass surface of one embodiment.

FIG. 14F shows for illustrative purposes only an example of a flexible slip and snap tempered glass cover installation pressed against a cell phone glass surface of one embodiment.

FIG. 14G shows for illustrative purposes only an example of a flexible slip and snap tempered glass cover installation tempered glass cover snap locking feature of one embodiment.

FIG. 15A shows for illustrative purposes only an example of a top and bottom two-part snap together digital device protective case with a coupled tempered glass covers of one embodiment.

FIG. 15B shows for illustrative purposes only an example of a bottom section of a two-part snap together digital device protective case with a coupled tempered glass back cover of one embodiment.

FIG. 15C shows for illustrative purposes only an example of a top section of a two-part snap together digital device protective case with a coupled tempered glass front cover of one embodiment.

FIG. 16A shows for illustrative purposes only an example of a two-part slide and snap together digital device protective case with glued tempered glass covers of one embodiment.

FIG. 16B shows for illustrative purposes only an example of a cell phone insertion into a slide receiver section of a two-part slide and snap together digital device protective case with glued tempered glass covers of one embodiment.

FIG. 16C shows for illustrative purposes only an example of sliding a slider section into a receiver section of a two-part slide and snap together digital device protective case with glued tempered glass covers of one embodiment.

FIG. 16D shows for illustrative purposes only an example of a cell phone installed in a two-part slide and snap together digital device protective case with glued tempered glass covers of one embodiment.

FIG. 17A shows for illustrative purposes only an example of a digital device protective case with glued tempered glass covers with a hinged snap section of one embodiment.

FIG. 17B shows for illustrative purposes only an example of a hinged snap section snap lock receptacle of one embodiment.

FIG. 17C shows for illustrative purposes only an example of a digital device protective case with glued tempered glass covers receiver section snap lock tab of one embodiment.

FIG. 17D shows for illustrative purposes only an example of a hinged snap section hinge in an opened position of one embodiment.

FIG. 17E shows for illustrative purposes only an example of a hinged snap section hinge in a closed position of one embodiment.

FIG. 17F shows for illustrative purposes only an example of a cell phone installed in a digital device protective case with glued tempered glass covers with a hinged snap section of one embodiment.

FIG. 18A shows a block diagram of an overview of liquid glass protector paddle applicator cleaning process of one embodiment.

FIG. 18B shows a block diagram of an overview of liquid glass protector paddle applicator application process of one embodiment.

FIG. 19A shows a block diagram of an overview of liquid glass protector paddle applicator cleaning side of one embodiment.

FIG. 19B shows a block diagram of an overview of cleaning fluid reservoir and pump of one embodiment.

FIG. 19C shows for illustrative purposes only an example of cleaning fluid pressured flow to sponge of one embodiment.

FIG. 19D shows for illustrative purposes only an example of cleaning and wiping process of one embodiment.

FIG. 20A shows for illustrative purposes only an example of liquid glass protector paddle applicator applying side of one embodiment.

FIG. 20B shows for illustrative purposes only an example of liquid glass suspension reservoir and pump of one embodiment.

FIG. 20C shows for illustrative purposes only an example of liquid glass application process of one embodiment.

FIG. 21 shows for illustrative purposes only an example of digital device protective case and cell phone screen spray cleaning process of one embodiment.

FIG. 22 shows for illustrative purposes only an example of digital device protective case and cell phone screen spray liquid glass protector application process of one embodiment.

FIG. 23 shows for illustrative purposes only an example of digital device protective case glass screen protector cleaning process of one embodiment.

FIG. 24 shows for illustrative purposes only an example of digital device protective case glass screen protector drip cleaning process isometric view of one embodiment.

FIG. 25A shows for illustrative purposes only an example of liquid glass vacuum release device of one embodiment.

FIG. 25B shows for illustrative purposes only an example of digital device protective case glass screen protector drip liquid glass protector application process of one embodiment.

FIG. 26 shows for illustrative purposes only an example of digital device protective case glass screen protector drip liquid glass protector application process isometric view of one embodiment.

FIG. 27 shows for illustrative purposes only an example of liquid glass sodium dioxide molecules of one embodiment.

FIG. 28 shows for illustrative purposes only an example of a dropper used to deposit liquid glass onto a glass screen protector of one embodiment.

FIG. 29 shows for illustrative purposes only an example of using a cloth to wipe liquid glass deposited by a dropper of one embodiment.

FIG. 30 shows for illustrative purposes only an example of spreading liquid glass using a wipe with absorbed liquid glass of one embodiment.

FIG. 31A shows for illustrative purposes only an example of an overview of four warranty plans of one embodiment.

FIG. 31B shows for illustrative purposes only an example of warranty digital device and accessories combinations of one embodiment.

FIG. 32 shows for illustrative purposes only an example of examples of digital devices eligible for warranty coverage of one embodiment.

FIG. 33 shows for illustrative purposes only an example of Warranty Plan A coverage of one embodiment.

FIG. 34 shows for illustrative purposes only an example of Warranty Plan B coverage of one embodiment.

FIG. 35 shows for illustrative purposes only an example of Warranty Plan C coverage of one embodiment.

FIG. 36 shows for illustrative purposes only an example of Warranty Plan D coverage of one embodiment.

FIG. 37 shows for illustrative purposes only an example of a digital device warranty purchaser registering their identification information input of one embodiment.

FIG. 38 shows for illustrative purposes only an example of a digital device warranty purchaser filing a damage claim of one embodiment.

FIG. 39A shows for illustrative purposes only an example of a Warranty Plan A first damage claim of one embodiment.

FIG. 39B shows for illustrative purposes only an example of a Warranty Plan A second damage claim of one embodiment.

FIG. 39C shows for illustrative purposes only an example of a Warranty Plan B first damage claim of one embodiment.

FIG. 39D shows for illustrative purposes only an example of a Warranty Plan B second damage claim of one embodiment.

FIG. 39E shows for illustrative purposes only an example of a Warranty Plan C first damage claim of one embodiment.

FIG. 39F shows for illustrative purposes only an example of a Warranty Plan C second damage claim of one embodiment.

FIG. 39G shows for illustrative purposes only an example of a Warranty Plan D first damage claim of one embodiment.

FIG. 39H shows for illustrative purposes only an example of a Warranty Plan D second damage claim of one embodiment.

FIG. 40 shows a block diagram of an overview of a phone case with an array of led lights of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview:

It should be noted that the descriptions that follow, for example, in terms of a digital device warranty method and devices is described for illustrative purposes and the underlying system can apply to any number and multiple types of warranties for phone case screen protectors and phone screen protectors. In one embodiment of the present invention, the digital device warranty method and devices can be configured for warranty coverage of unfoldable and foldable digital devices and digital device screen protectors, tablets and other handheld or portable digital devices with screen protectors as well as smart watches and other wearable accessories. The digital device warranty method and devices can be configured to include warranty coverage for the entirety of digital device components and can be configured to include warranty coverage for all types of digital device screen protectors and phone screens using the embodiments.

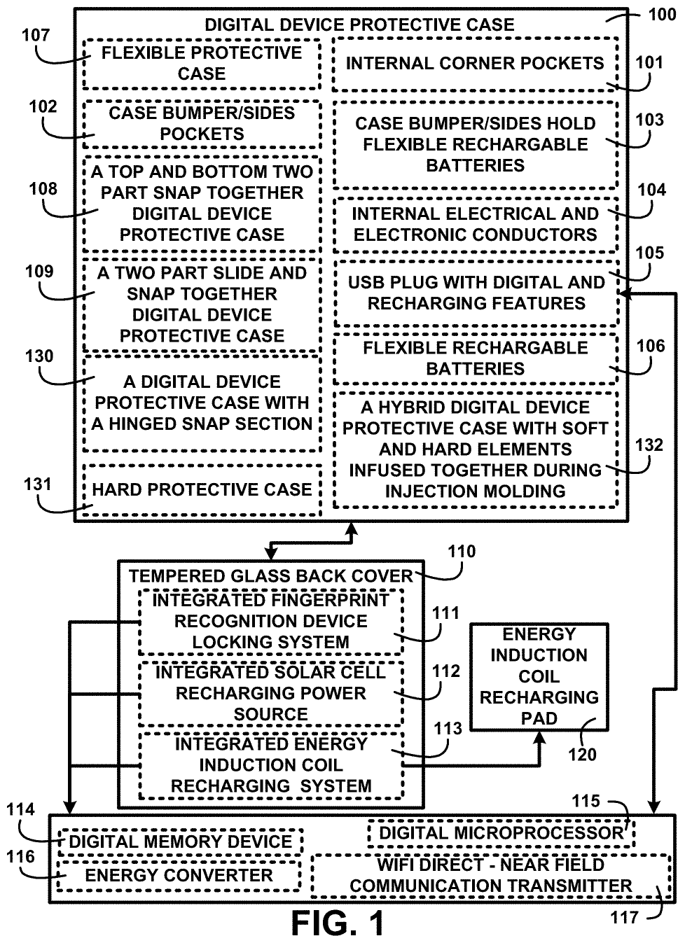

FIG. 1 shows a block diagram of an overview of a digital device protective case method and device of one embodiment. FIG. 1 shows a digital device protective case 100 can include a flexible protective case 107, a digital device protective case including case bumper/sides pockets 101 and case bumper/sides 102, a top and bottom two-part snap together protective case 108, a two-part slide and snap together protective case 109, a protective case with a hinged snap section 130, a hard protective case 131, and a hybrid protective case with soft and hard elements infused together during injection molding 132. Case bumper/sides pockets hold flexible rechargeable batteries 103. The case bumper/sides 102 are also configured to be a chase to install internal electrical and electronic conductors 104 of one embodiment.

A USB plug with digital and recharging features 105 is configured to be inserted in a typical cell phone USB recharging and data link receptacle. The USB plug with digital and recharging features 105 is configured to include a digital memory device 114, a digital microprocessor 115, an energy converter 116, and WIFI direct—near field communication transmitter 117. Flexible rechargeable batteries 106 are configured to be charged by digital device protective case device tempered glass back cover 110 power source features of one embodiment.

The tempered glass back cover 110 is configured to include an integrated fingerprint recognition device locking system 111, an integrated solar cell recharging power source 112 and an integrated energy induction coil recharging system 113. The integrated energy induction coil recharging system 113 can intake power from an energy induction coil recharging pad 120. Throughout the description reference is made to tempered glass which is for ease of the description, but laminated glass could in all instances be interpreted as another type of glass to be used of one embodiment.

### DETAILED DESCRIPTION

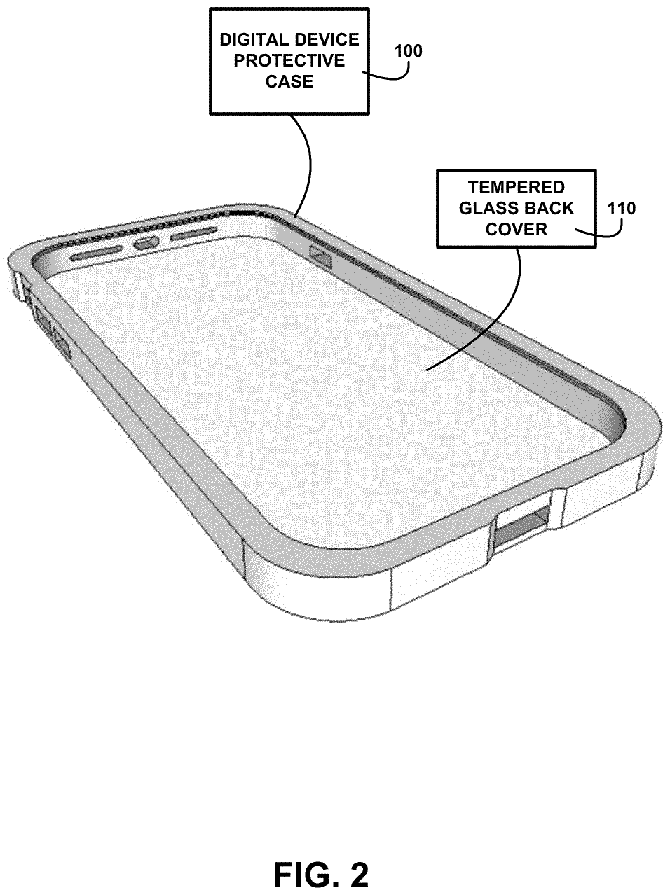

FIG. 2 shows for illustrative purposes only an example of a digital device protective case of one embodiment. FIG. 2 shows the digital device protective case 100 with the tempered glass back cover 110 installed of one embodiment.

### Digital Device Protective Case Longitudinal Cross Section:

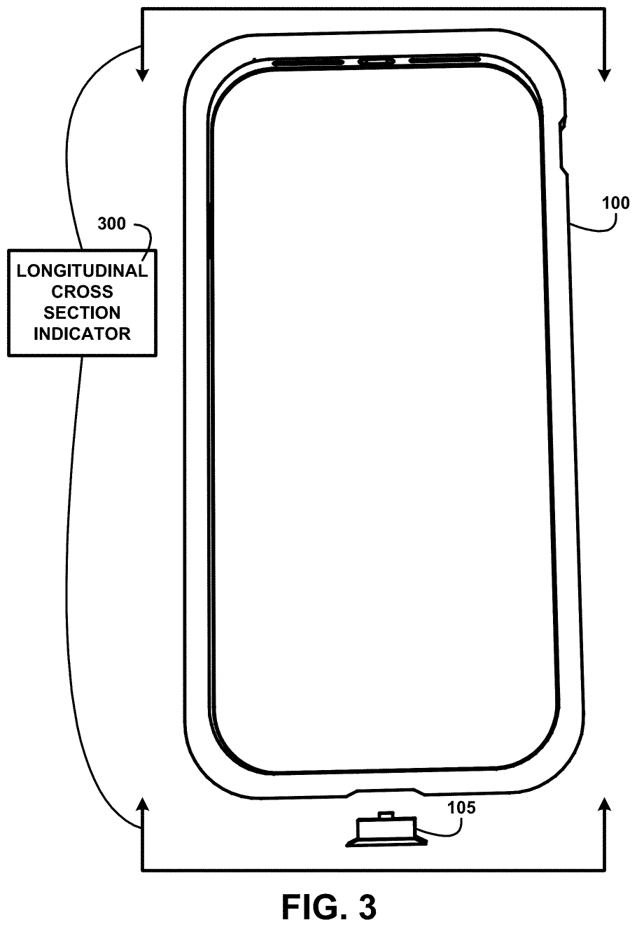

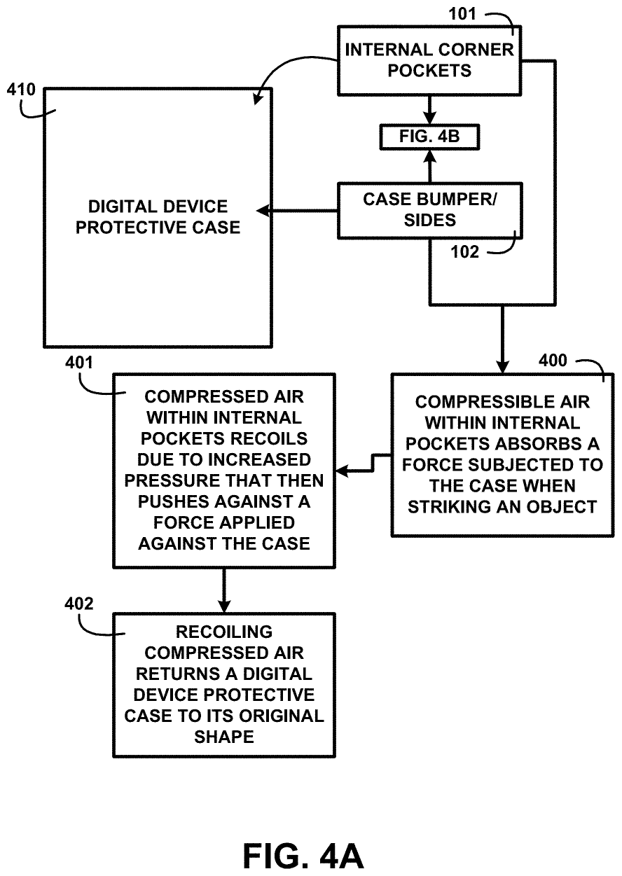

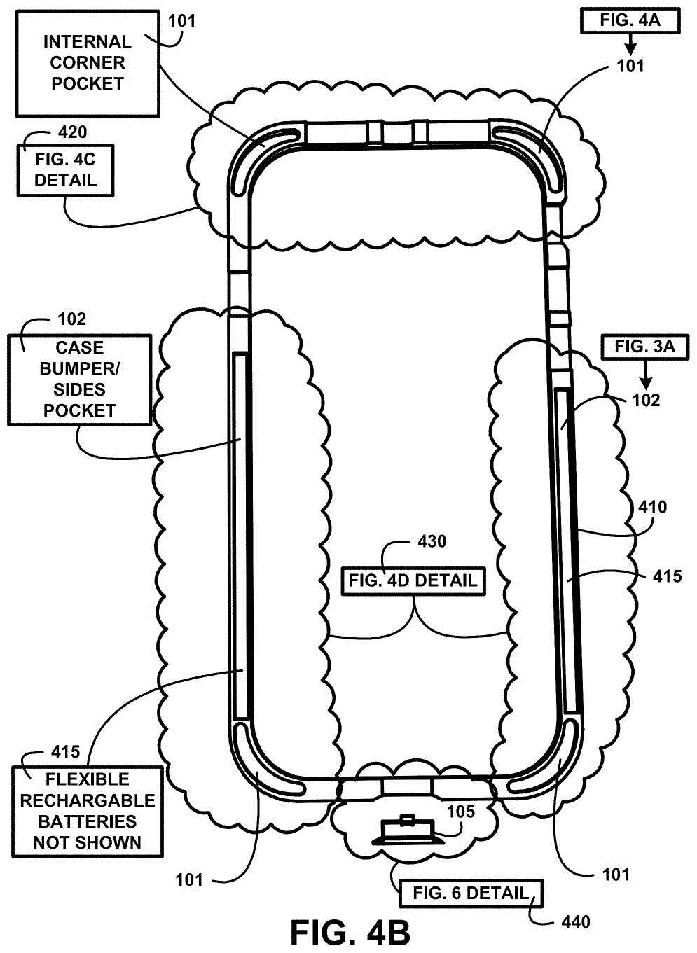

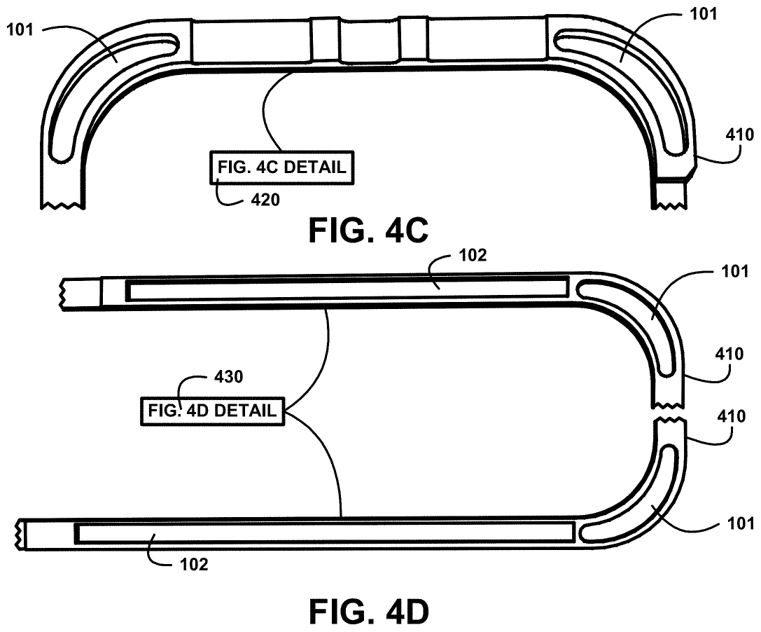

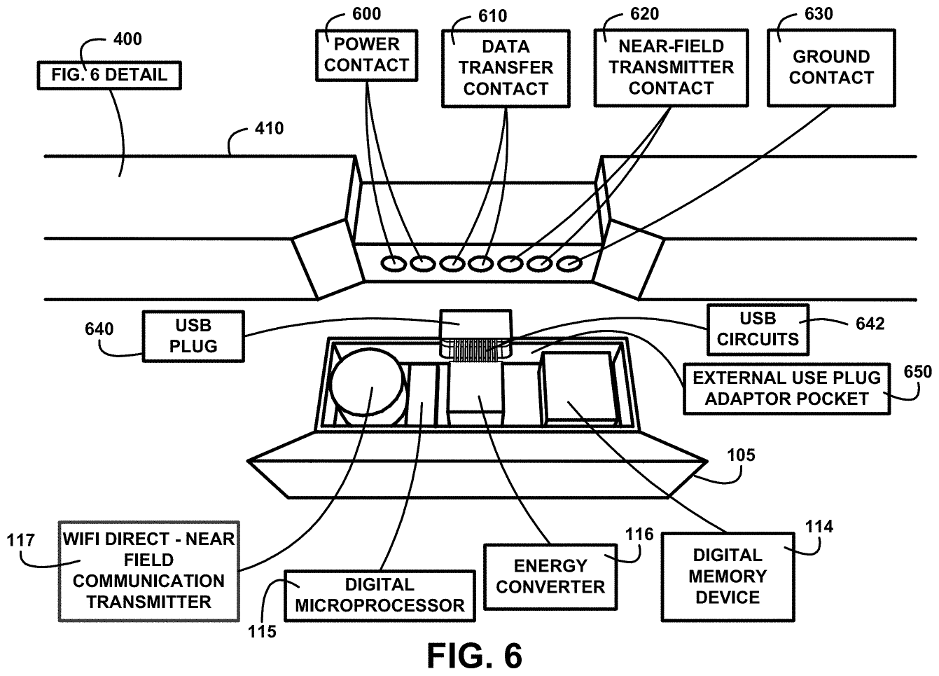

FIG. 3 shows for illustrative purposes only an example of a digital device protective case longitudinal cross section of one embodiment. FIG. 3 shows the digital device protective case 100 made with for example a flexible rubber made of thermoplastic polyurethane (TPU). Air cushion pockets can be integrated into a mold and molding process. The FIG. 3 illustration also shows two longitudinal cross section indicator 300 to show the relationship to the cross section shown in FIG. 4B. Also shown is the USB plug with digital and recharging features 105 shown in more detail in FIG. 6 of one embodiment.

### Digital Device Protective Case Air Cushion Pockets:

FIG. 4A shows a block diagram of an overview of a digital device protective case bumper/sides pockets of one embodiment. FIG. 4A shows the digital device protective case 410 that includes the integrated case bumper/sides pockets 101 and case bumper/sides 102 shown in more detail in FIG. 4B. Compressible air within internal air cushion pockets absorbs a force subjected to the case when striking an object 400. Compressed air within internal air cushion pockets recoils due to increased pressure that then pushes against a force applied against the case 401. Recoiling compressed air returns a digital device protective case to its original shape 402 of one embodiment.

### Corner Air Cushion Pockets:

FIG. 4B shows for illustrative purposes only an example of case bumper/sides pockets of one embodiment. FIG. 4B shows the longitudinal cross section indicated in FIG. 4A. Clearly visible is the case bumper/sides pocket 101 also shown in FIG. 4C detail 420. Visible also is the internal bumper side 102. The case bumper/sides 102 cavities are configured to hold flexible rechargeable batteries not shown 415. The case bumper/sides 102 are also shown in FIG. 4D detail 430. FIG. 4B shows the USB plug with digital and recharging features 105 that plugs into the digital device protective case 410 and cell phone installed in the digital device protective case 410. A detailed view of the USB plug with digital and recharging features 105 is shown in FIG. 6 detail 440 of one embodiment.

### Corner Air Cushion Pockets:

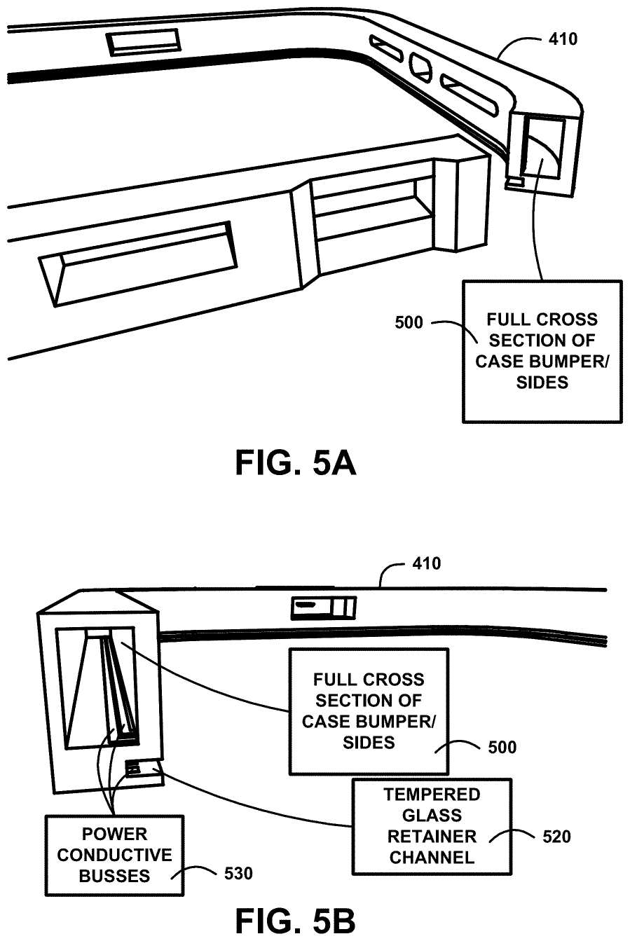

FIG. 4C shows for illustrative purposes only an example of corner case bumper pockets of one embodiment. FIG. 4C shows the digital device protective case 410 including FIG. 4C detail 420 of two of the case bumper/sides pocket 101 features. FIG. 5A shows a view of the full case bumper/sides pocket 101 of one embodiment.

### Side Air Cushion Pockets:

FIG. 4D shows for illustrative purposes only an example of case bumper/sides pockets of one embodiment. FIG. 4D shows FIG. 4D detail 430 of the case bumper/sides 102 features. The digital device protective case 410 includes the case bumper/sides pocket 101 which shows a position relationship to the case bumper/sides 102 of one embodiment.

### Full Cross Section of Case Bumper/Sides Pocket:

FIG. 5A shows for illustrative purposes only an example of a full cross section of case bumper/sides pocket of one embodiment. FIG. 5A shows the digital device protective case 410 with a full cross section of case bumper/sides 500 cavity of one embodiment.

### Tempered Glass Retainer Channel:

FIG. 5B shows for illustrative purposes only an example of a tempered glass retainer channel of one embodiment. FIG. 5B shows the digital device protective case 410 with a full cross section of a bumper/side 510 including a tempered glass retainer channel 520. Power conductive busses 530 are shown installed into the channel inside the case bumper/sides 102. The power conductive busses 530 extend thru the digital device protective case 410 and are exposed in the tempered glass retainer channel 520. A conductive contact can be made here between the power conductive busses 530 and circuit terminal contacts of the flexible rechargeable batteries 106, the integrated solar cell recharging power source 112, and the integrated energy induction coil recharging system 113 of one embodiment.

USB Plug with Digital and Recharging Features:

FIG. 6 shows for illustrative purposes only an example of a USB plug with digital and recharging features of one embodiment. FIG. 6 shows the digital device protective case 410 and the FIG. 6 detail 440 of the USB plug with digital and recharging features 105. The digital device protective case 410 is configured to include at the USB port power contact 600, data transfer contact 610, near-field transmitter contact 620, and ground contact 630.

The USB plug with digital and recharging features 105 is configured to include a USB plug 640, USB circuits 642 and an external use plug adaptor pocket 650. The external use plug adaptor pocket 650 is configured to form a compartment for installations of a WIFI direct—near field communication transmitter 117, the digital microprocessor 115, the energy converter 116, and the digital memory device 114 of one embodiment.

### Integrating External Universal Fingerprint Thermal Recognition System:

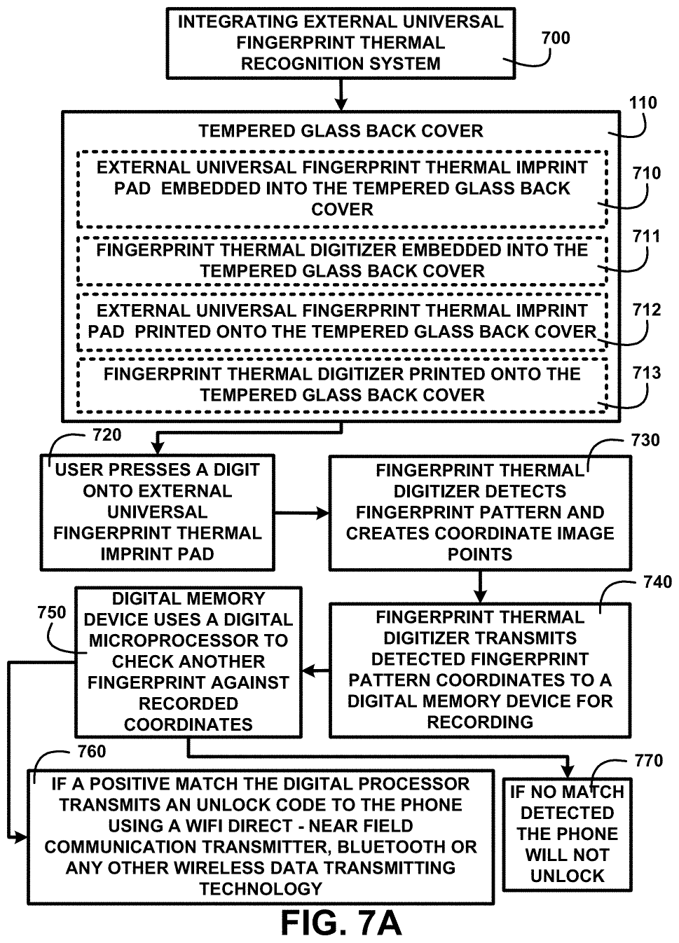

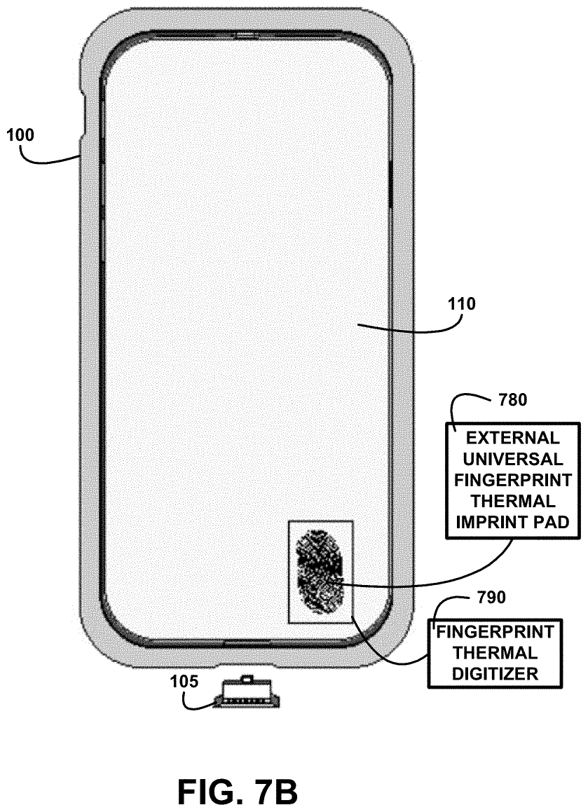

FIG. 7A shows a block diagram of an overview of an integrating external universal fingerprint thermal recognition system of one embodiment. FIG. 7A shows an integrating external universal fingerprint thermal recognition system 700 to the tempered glass back cover 110. Integrating external universal fingerprint thermal recognition system 700 can include using an external universal fingerprint thermal imprint pad embedded into the tempered glass back cover 710, fingerprint thermal digitizer embedded into the tempered glass back cover 711, external universal fingerprint thermal imprint pad printed onto the tempered glass back cover 712, and fingerprint thermal digitizer printed onto the tempered glass back cover 713 of one embodiment.

A user presses a digit onto external universal fingerprint thermal imprint pad 720. A fingerprint thermal digitizer detects fingerprint pattern and creates coordinate image points 730. A fingerprint thermal digitizer transmits detected fingerprint pattern coordinates to a digital memory device for recording 740. A digital memory device uses a digital microprocessor to check another fingerprint against recorded coordinates 750. If a positive match the digital processor transmits an unlock code to the phone using a Wi-Fi direct—near field communication transmitter, Bluetooth or any other wireless data transmitting technology 760. If no match detected the phone will not unlock 770. Integrating external universal fingerprint thermal recognition system 700 into the digital device protective case 100 of FIG. 1 can provide a user with a sophisticated locking system that is not a normal feature of their existing cell phone of one embodiment.

### External Universal Fingerprint Thermal Imprint Pad:

FIG. 7B shows for illustrative purposes only an example of external universal fingerprint thermal imprint pad of one embodiment. FIG. 7B shows the digital device protective case 100 with the tempered glass back cover 110 installed. The USB plug with digital and recharging features 105 is also installed (not shown). The tempered glass back cover 110 includes an external universal fingerprint thermal imprint pad 780 and fingerprint thermal digitizer 790 integrated with the tempered glass back cover 110 of one embodiment. In another embodiment an external universal fingerprint thermal imprint pad 780 is located on a front screen protector and fingerprint thermal digitizer 790 integrated with the front screen protector. In yet another embodiment an external universal fingerprint thermal imprint pad 780 is located on a perimeter space of the digital device protective case 100.

### Integrating Case External Universal Flexible Photo/Light Power Converters:

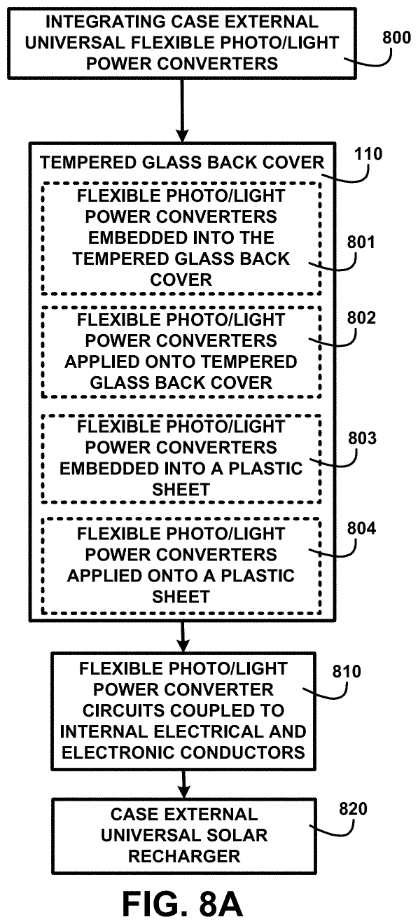

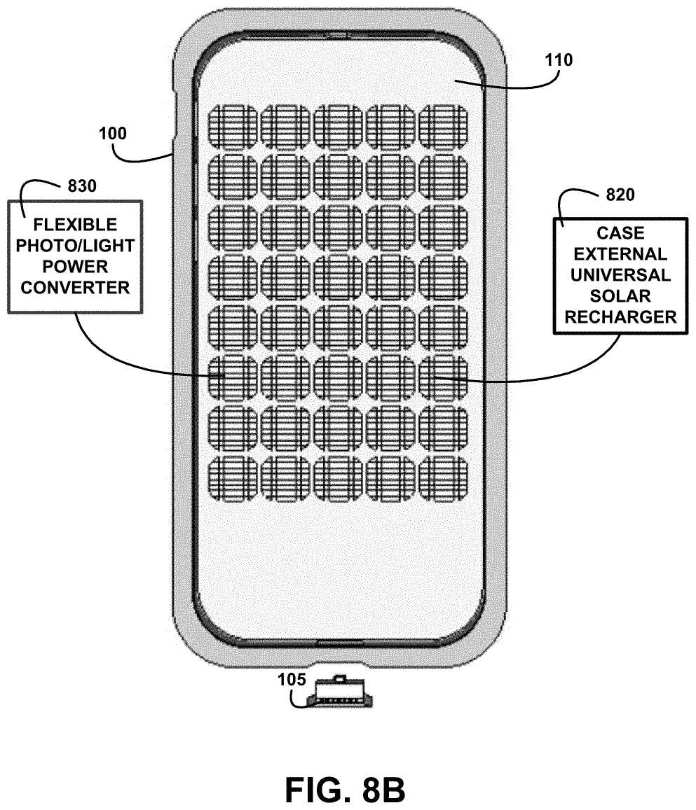

FIG. 8A shows a block diagram of an overview of an integrating case external universal flexible photo/light power converters of one embodiment. FIG. 8A shows integrating case external universal flexible photo/light power converters 800 to the tempered glass back cover 110. Integrating case external universal flexible photo/light power converters 800 can include using a flexible photo/light power converters embedded into the tempered glass back cover 801, a flexible photo/light power converters applied onto tempered glass back cover 802, a flexible photo/light power converters embedded into a plastic sheet 803, and a flexible photo/light power converters applied onto a plastic sheet 804 of one embodiment.

Flexible photo/light power converter circuits coupled to internal electrical and electronic conductors 810 creates a case external universal solar recharger 820. Integrating case external universal flexible photo/light power converters 800 into the digital device protective case 100 of FIG. 1 can provide a user with a sophisticated solar recharger system that is not a normal feature of their existing cell phone of one embodiment.

### Case External Universal Solar Recharger:

FIG. 8B shows for illustrative purposes only an example of case external universal solar recharger of one embodiment. FIG. 8B shows the digital device protective case 100 with the tempered glass back cover 110 installed. The tempered glass back cover 110 includes an array of a plurality of flexible photo/light power converter 830 devices to create a case external universal solar recharger 820. Also shown is the USB plug with digital and recharging features 105 of one embodiment.

### Integrating Case External Universal Energy Induction Coils:

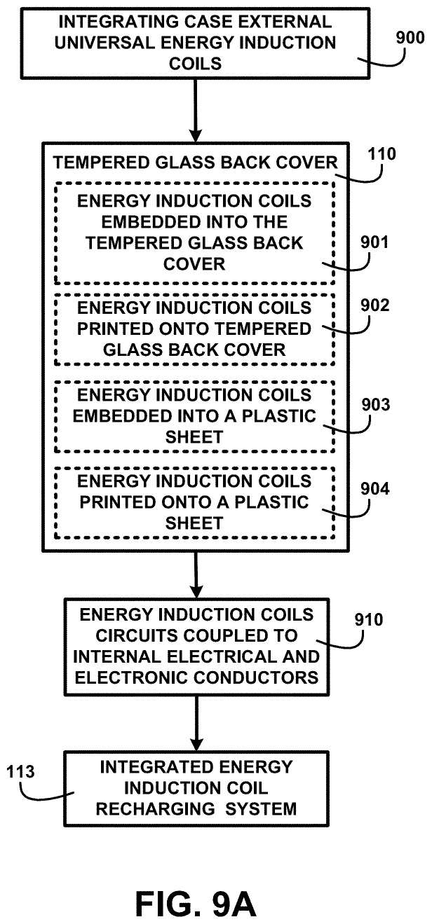

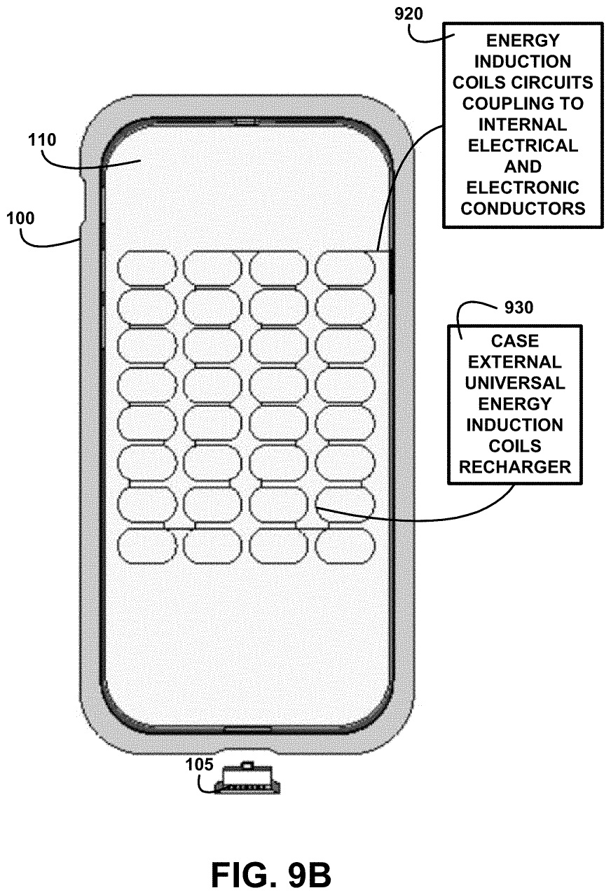

FIG. 9A shows a block diagram of an overview of an integrating case external universal energy induction coils of one embodiment. FIG. 9A shows integrating case external universal energy induction coils 900 to the tempered glass back cover 110. Integrating case external universal energy induction coils 900 can be done using an energy induction coils embedded into the tempered glass back cover 901, an energy induction coils printed onto tempered glass back cover 902, an energy induction coils embedded into a plastic sheet 903, and an energy induction coils printed onto a plastic sheet 904. Energy induction coils circuits coupled to internal electrical and electronic conductors 910 creates the integrated energy induction coil recharging system 113.

In one embodiment the Energy induction coils circuits coupled to internal electrical and electronic conductors 910 are connected to the flexible rechargeable batteries 106 of FIG. 1. The integrated energy induction coil recharging system 113 when placed on the energy induction coil recharging pad 120 of FIG. 1 charges the flexible rechargeable batteries 106.

In another embodiment the flow of power stored in the flexible rechargeable batteries 106 of FIG. 1 can be reversed wherein the electricity flows into the energy induction coil array integrated to the tempered glass back cover 110 wherein the energy passes from the energy induction coil array to a wireless charging system installed in a cell phone including a smart phone. The cell phone wireless charging is based on the principle of magnetic resonance, or Inductive Power Transfer (IPT). This is the process of transferring an electrical current between two objects through the use of coils to induce an electromagnetic field. This allows a user to have the convenience of wireless charging from the digital device protective case with the tempered glass back cover 110 of FIG. 1 with integrated case external universal energy induction coils while remaining active and on the go without having to wait while the user's cell phone is wirelessly charging setting on a wirelessly charging pad or device.

### Case External Universal Energy Induction Coils Recharger:

FIG. 9B shows for illustrative purposes only an example of case external universal energy induction coils recharger of one embodiment. FIG. 9B shows the digital device protective case 100 with the tempered glass back cover 110 installed. Also shown is the USB plug with digital and recharging features 105. Energy induction coils circuits coupling to internal electrical and electronic conductors 920 create a case external universal energy induction coils recharger 930 of one embodiment.

### Case External Universal Energy Induction Coils Recharging Pad:

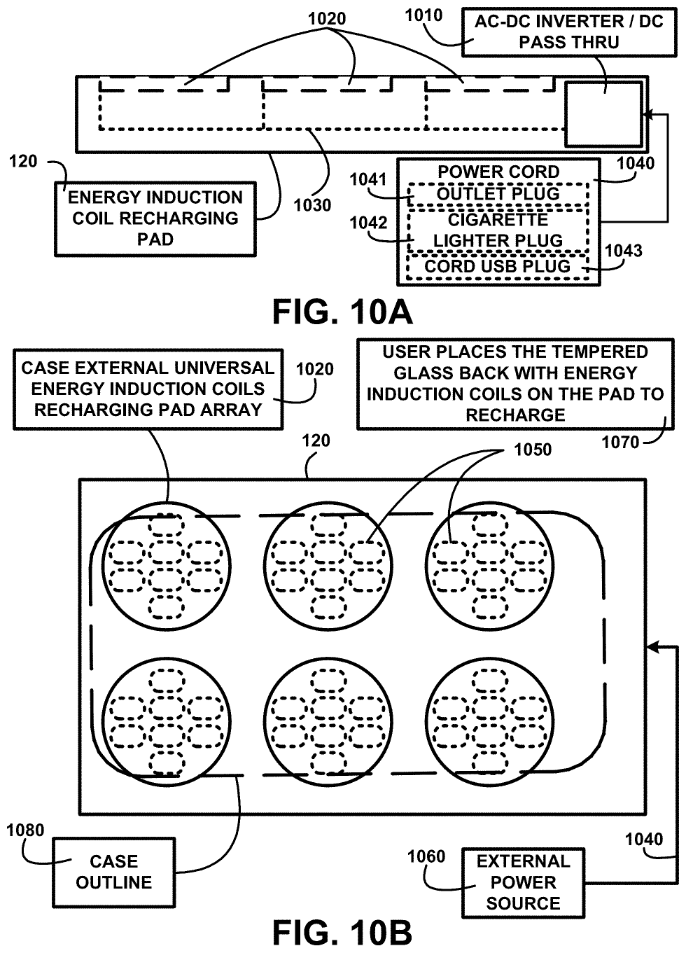

FIG. 10A shows for illustrative purposes only an example of a case external universal energy induction coils recharging pad of one embodiment. FIG. 10A shows the energy induction coil recharging pad 120 in a side view including at least one case external universal energy induction coils recharging pad array 1020. An AC-DC inverter/DC pass thru 1010 is coupled to a power cord 1040 configured with an interchangeable outlet plug 1041, cigarette lighter plug 1042 and cord USB plug 1043. The AC-DC inverter/DC pass thru 1010 is coupled to a power cord 1040 configured with an interchangeable outlet plug 1041, cigarette lighter plug 1042 and cord USB plug 1043 can be respectively inserted into a typical house current outlet, a cigarette lighter in a vehicle or to a powered device with a USB outlet of one embodiment.

### Case External Universal Energy Induction Coils Recharging Pad Array:

FIG. 10B shows for illustrative purposes only an example of a case external universal energy induction coils recharging pad array of one embodiment. FIG. 10B shows the energy induction coil recharging pad 120 top view that shows a plurality of energy induction coil 1050, the power cord 1040 coupled to an external power source 1060. The case external universal energy induction coils recharging pad array 1020 is used when a user places the tempered glass back with energy induction coils on the pad to recharge 1070 as shown with a case outline 1080 of one embodiment.

Case with Glue Ledge:

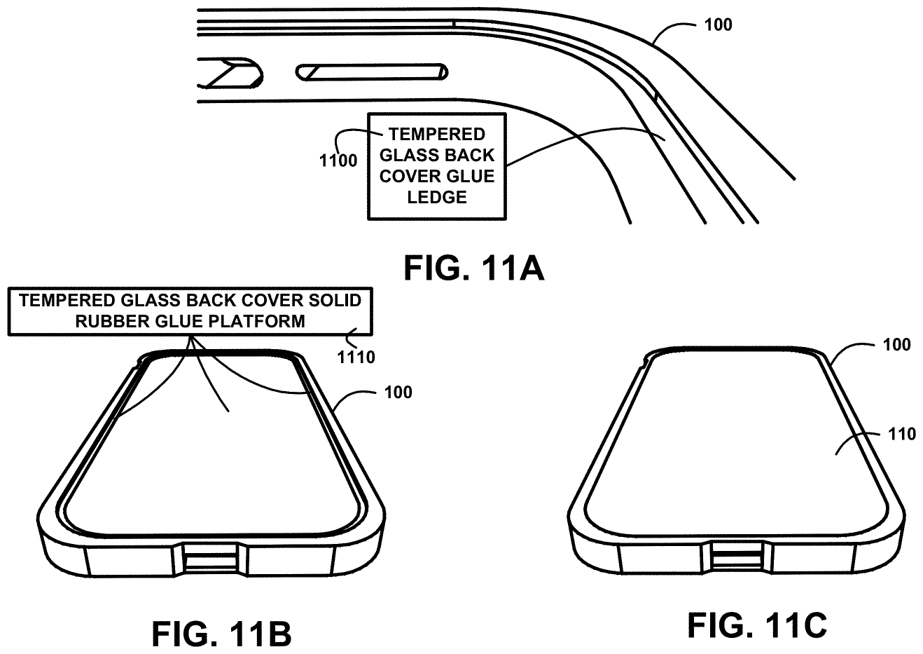

FIG. 11A shows for illustrative purposes only an example of case with glue ledge of one embodiment. FIG. 11A shows the digital device protective case 100 molded to include a tempered glass back cover glue ledge 1100. The tempered glass back cover glue ledge 1100 is configured for applying a glue or an adhesive strip to bond the tempered glass back cover 110 of FIG. 1 to the digital device protective case 100 wherein the tempered glass back cover glue ledge 1100 is configured to position the tempered glass back cover glue ledge 1100 is configured for applying a glue or an adhesive strip to bond the tempered glass back cover 110 of FIG. 1 outside surface flush with the adjacent case face of one embodiment.

Case with Solid Rubber Glue Platform:

FIG. 11B shows for illustrative purposes only an example of case with solid rubber glue platform of one embodiment. FIG. 11B shows the digital device protective case 100 molded to include a tempered glass back cover solid rubber glue platform 1110. The tempered glass back cover solid rubber glue platform 1110 is configured for applying a glue or an adhesive strip onto the surface of the tempered glass back cover solid rubber glue platform 1110 to bond the tempered glass back cover 110 of FIG. 1 to the digital device protective case 100 of one embodiment.

Digital Device Protective Case with Glued Tempered Glass Back:

FIG. 11C shows for illustrative purposes only an example of digital device protective case with glued tempered glass back of one embodiment. FIG. 11C shows the digital device protective case 100 with a tempered glass back cover 110 glued or attached with an adhesive to the back side of the digital device protective case 100 of one embodiment.

In another embodiment the tempered glass back cover 110 can be configured to be attached with magnets to the back of any other type of cell phone case to provide additional protection.

### Installing a Tempered Glass Front Cover Process:

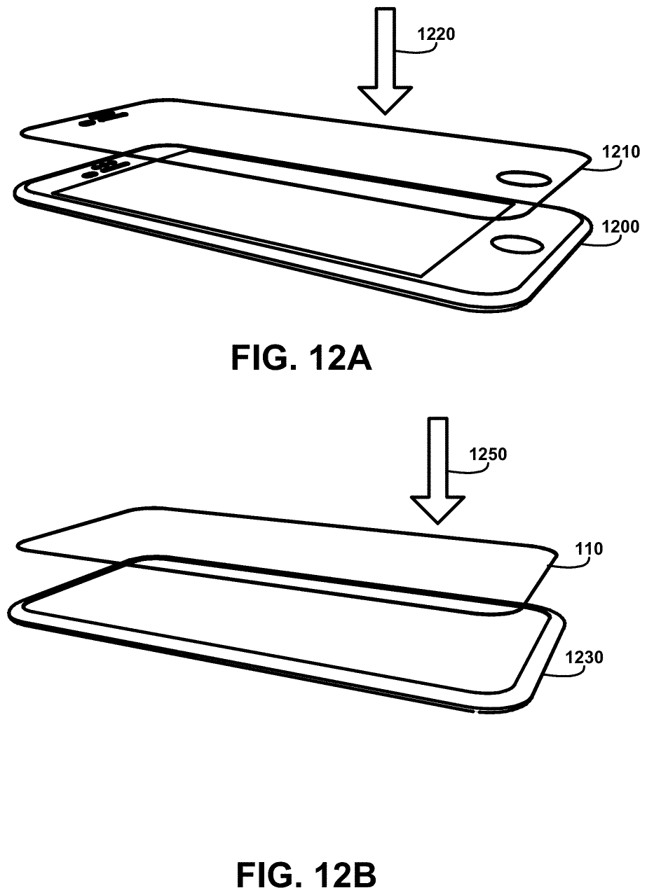

FIG. 12A shows for illustrative purposes only an example of installing a tempered glass front cover of one embodiment. FIG. 12A shows installing a tempered glass front cover on the surface of a cell phone 1220. The cell phone 1200 front screen has a glass surface. In one embodiment an installation process begins with wiping clean the glass surface of the cell phone 1200. A tempered glass front cover 1210 is positioned on the screen glass surface to match edges. The installation process continues with sliding with pressure applied a dry clean cloth from the center of the screen area outward to the edges to push air that may be trapped between the tempered glass front cover 1210 and the glass surface of the cell phone 1200. The tempered glass front cover 1210 will be coupled to the glass surface of the cell phone 1200 by the static friction occurring between the two glass surfaces of one embodiment.

A digital device protective case may also be referred to herein with the term “bumper” without any change in meaning. A digital device protective case including a digital device protective case made of a hard plastic, or metal, or a hybrid made of two parts wherein one part is a hard plastic and the other part is a soft flexible plastic and wherein the two parts are fused together in a process or the digital device protective case 100 of FIG. 1 can be installed around the cell phone 1200 with the tempered glass front cover 1210 of one embodiment.

In another embodiment a liquid glass solution is deposited using a dropper, or a spray device, or a bottle for pouring onto a glass surface of the cell phone 1200. The deposited liquid glass is spread over the entire glass surface of the cell phone 1200 using a cloth to wipe the liquid glass over the glass surface. A tempered glass front cover 1210 is positioned on the glass surface of the cell phone 1200 on the deposited liquid glass.

In yet another embodiment a tempered glass front cover 1210 is positioned on the glass surface of the cell phone 1200 and a liquid glass solution is deposited using a dropper onto the surface of the tempered glass front cover 1210. The deposited liquid glass is spread over the entire glass surface of the tempered glass front cover 1210 using a cloth to wipe the liquid glass over the tempered glass front cover 1210.

In other embodiments a wipe material towelette with an absorbed liquid glass solution is used to deposit and spread in a wiping process the absorbed liquid glass solution onto and across the entire glass surface of a glass surface of the cell phone 1200 or tempered glass front cover 1210.

### Installing a Tempered Glass Back Cover Process:

FIG. 12B shows for illustrative purposes only an example of installing a tempered glass back cover of one embodiment. FIG. 12B shows installing a tempered glass back cover on the surface of a cell phone back side 1250. The cell phone back side 1230 may have a glass surface. In one embodiment an installation process begins with wiping clean the glass surface of the cell phone back side 1230. A tempered glass back cover 110 is positioned on the screen glass surface to match edges. The installation process continues with sliding with pressure applied a dry clean cloth from the center of the screen area outward to the edges to push air that may be trapped between the tempered glass back cover 110 and the glass surface of the cell phone back side 1230. The tempered glass back cover 110 will be coupled to the glass surface of the cell phone back side 1230 by the static friction occurring between the two glass surfaces. A protective case including the digital device protective case 100 of FIG. 1, a hard plastic bumper, and a metal bumper can be installed around the cell phone 1200 of FIG. 12A with the tempered glass back cover 110 of one embodiment.

In another embodiment a liquid glass solution is deposited using a dropper onto a cell phone back side 1230 with a glass surface. The deposited liquid glass is spread over the entire cell phone back side 1230 with a glass surface using a cloth to wipe the liquid glass over the glass surface. A tempered glass back cover 110 is positioned on the cell phone back side 1230 with a glass surface on the deposited liquid glass.

In yet another embodiment a tempered glass back cover 110 is positioned on the cell phone back side 1230 with a glass surface and a liquid glass solution is deposited using a dropper onto the surface of the tempered glass back cover 110. The deposited liquid glass is spread over the entire glass surface of the tempered glass back cover 110 using a cloth to wipe the liquid glass over the tempered glass back cover 110.

In other embodiments a wipe material towelette with an absorbed liquid glass solution is used to deposit and spread in a wiping process the absorbed liquid glass solution onto and across the entire glass surface of a cell phone back side 1230 with a glass surface or tempered glass back cover 110.

### Printed Tempered Glass Front Cover:

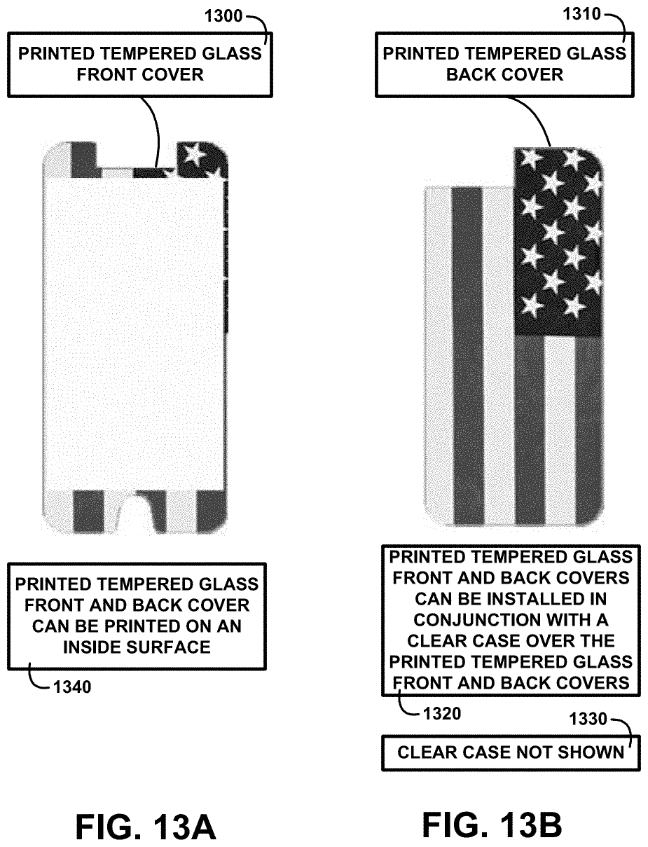

FIG. 13A shows for illustrative purposes only an example of a printed tempered glass front cover of one embodiment. FIG. 13A shows a printed tempered glass front cover 1300. The printed tempered glass front cover 1300 can include any image to be printed on those portions of the tempered glass front cover that are not cut out for cell phone buttons, tabs or other protuberances, and may be clear for example to see the cell phone screen. A printed tempered glass front and back cover can be printed on an inside surface 1340. Other embodiments include tempered glass front and back matching designs, or tempered glass front and phone case matching designs, or all matching design tempered glass front, printed phone case and digital downloadable image that the designs will be same to give a wrap effect on the phone with same design, or printed front and back tempered glass with same design, coupled with same print bumper, or printed front and back tempered glass with same design, coupled with a clear bumper.

### Printed Tempered Glass Back Cover:

FIG. 13B shows for illustrative purposes only an example of a printed tempered glass back cover of one embodiment. FIG. 13B shows a printed tempered glass back cover 1310. The printed tempered glass back cover 1310 can include any image to be printed on those portions of the tempered glass back cover that are not cut out for cell phone buttons, tabs or other protuberances. Printed tempered glass front and back covers can be installed in conjunction with a clear case over the printed tempered glass front and back covers 1320, the clear case not shown 1330 of one embodiment.

### Slip and Snap Tempered Glass Cover Installation Features:

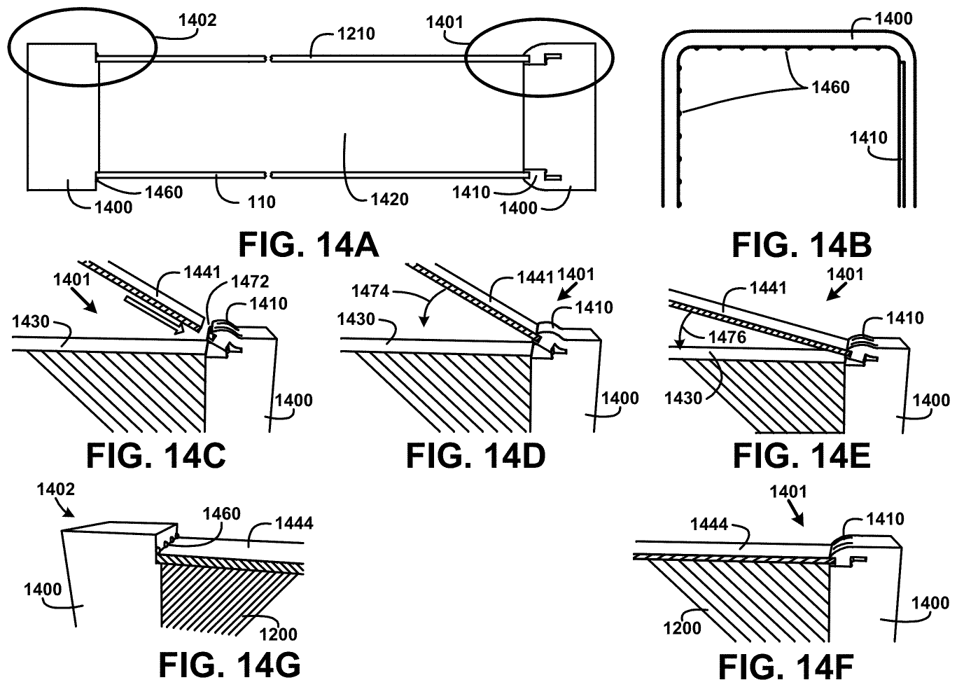

FIG. 14A shows for illustrative purposes only an example of a profile view of a digital device protective case with slip and snap tempered glass cover installation features of one embodiment. FIG. 14A shows in one embodiment a digital device protective case with slip and snap tempered glass cover installation features 1400. The digital device protective case with slip and snap tempered glass cover installation features 1400 aids in positioning a tempered glass front cover 1210 and a tempered glass back cover 110 on a cell phone 1420. The digital device protective case with slip and snap tempered glass cover installation features 1400 can include the slip and snap tempered glass cover installation features on one or both sides of the case. The slip and snap tempered glass cover installation features include a flexible slotted tab 1410 along one longitudinal inner edge of the digital device protective case with slip and snap tempered glass cover installation features 1400. The flexible slotted tab 1410 is shown in more detail in detail 1401 and other FIGs. including 14C-F.

In another embodiment a magnetized metal case border would be used to hold the tempered glass cover that includes a metal strip coupled to the perimeter of the tempered glass cover. The magnetic coupling would hold the tempered glass cover in place.

The slip and snap tempered glass cover installation features include a plurality of snap locking features 1460 appearing as protuberances spaced along the other three inner edges of the digital device protective case with slip and snap tempered glass cover installation features 1400. The snap locking feature is shown in more detail in detail 1402 and FIG. 14B and FIG. 14G of one embodiment.

A Digital Device Protective Case with Slip and Snap Tempered Glass Cover Installation Features:

FIG. 14B shows for illustrative purposes only an example of a top view of a digital device protective case with slip and snap tempered glass cover installation features of one embodiment. FIG. 14B shows in one embodiment a digital device protective case with slip and snap tempered glass cover installation features 1400. Shown is the flexible slotted tab 1410 along one longitudinal inner edge of the digital device protective case with slip and snap tempered glass cover installation features 1400. Also showing is a plurality of snap locking features 1460 appearing as protuberances spaced along the other three inner edges of the digital device protective case with slip and snap tempered glass cover installation features 1400 of one embodiment.

Slipping a Tempered Glass Cover into a Flexible Slotted Tab:

FIG. 14C shows for illustrative purposes only an example of slipping a tempered glass cover into a slip and snap tempered glass cover slot installation feature of one embodiment. FIG. 14C shows slipping a tempered glass cover into a flexible slotted tab 1410 pulled up to expose a receiver slot 1472 for the tempered glass cover 1441 angled. Also showing is the digital device protective case with slip and snap tempered glass cover installation features 1400 and a glass surface of one side of a cell phone 1430 of one embodiment.

### Pushed Towards a Cell Phone Glass Surface:

FIG. 14D shows for illustrative purposes only an example of a flexible slip and snap tempered glass cover installation feature pushed towards a cell phone glass surface of one embodiment. FIG. 14D shows a tempered glass cover 1441 installed into a flexible slotted tab 1410 of the digital device protective case with slip and snap tempered glass cover installation features 1400. The angled flexible slotted tab 1410 and tempered glass cover 1441 is then pushed towards 1474 the glass surface of one side of a cell phone 1430. The flexible slotted tab 1410 can be made with for example a flexible rubber including thermoplastic polyurethane (TPU). The flexible slotted tab 1410 will have a recoil tension force built up when retracted into an angled position. This will aid in the pushing action. The flexible slotted tab 1410 is configured to return to its flattened position to position the insert tempered glass cover 1441 along the inner longitudinal inner edge which will position the whole tempered glass cover 1441 over the glass surface of one side of a cell phone 1430. The tempered glass cover 1441 also maintains some flexing. The tempered glass is held by the flexible slotted tab 1410 and provides an object to flex or bend the tempered glass presenting a curved surface towards the cell phone glass surface. Flexing the tempered glass cover 1441 during the pushing action will allow the flexed curved surface to touch the glass surface of one side of a cell phone 1430 nearest the flexible slotted tab 1410 first. The remainder of the curved surface will flatten as contact with the glass surface is made. Gradually the curved surface contact will push air out from between the tempered glass cover 1441 and glass surface of the cell phone of one embodiment.

### Continuing a Push Toward a Cell Phone Glass Surface:

FIG. 14E shows for illustrative purposes only an example of a flexible slip and snap tempered glass cover installation feature continuing a push toward a cell phone glass surface of one embodiment. FIG. 14E shows continuing pushing 1476 the tempered glass cover 1441 onto the glass surface of the cell phone. FIG. 14E is also showing the flexible slotted tab 1410 recoiling to the digital device protective case with slip and snap tempered glass cover installation features 1400. The flexed temper glass cover 1441 outward bend is facing the glass surface of one side of a cell phone 1430 of one embodiment,

### Tempered Glass Cover Pressed Against a Cell Phone Glass Surface:

FIG. 14F shows for illustrative purposes only an example of a flexible slip and snap tempered glass cover installation pressed against a cell phone glass surface of one embodiment. FIG. 14F shows detail 1401 showing a tempered glass cover pressed against a cell phone glass surface in a flexible slip and snap tempered glass cover installation. The flexible slotted tab 1410 is shown recoiled to its original position on the digital device protective case with slip and snap tempered glass cover installation features 1400 installed on the cell phone 1420. The flattened tempered glass cover 1444 is coupled to the glass surface of one side of a cell phone 1430 of FIG. 4C of one embodiment.

### Tempered Glass Cover Snap Locking Feature:

FIG. 14G shows for illustrative purposes only an example of a flexible slip and snap tempered glass cover installation tempered glass cover snap locking feature of one embodiment. FIG. 14G shows detail 1402 of the digital device protective case with slip and snap tempered glass cover installation features 1400 installed on the cell phone 1420. The flattened tempered glass cover 1444 is pressed beneath the plurality of snap locking features 1460 of one embodiment.

### Two-Part Snap Together Digital Device Protective Case Orientation:

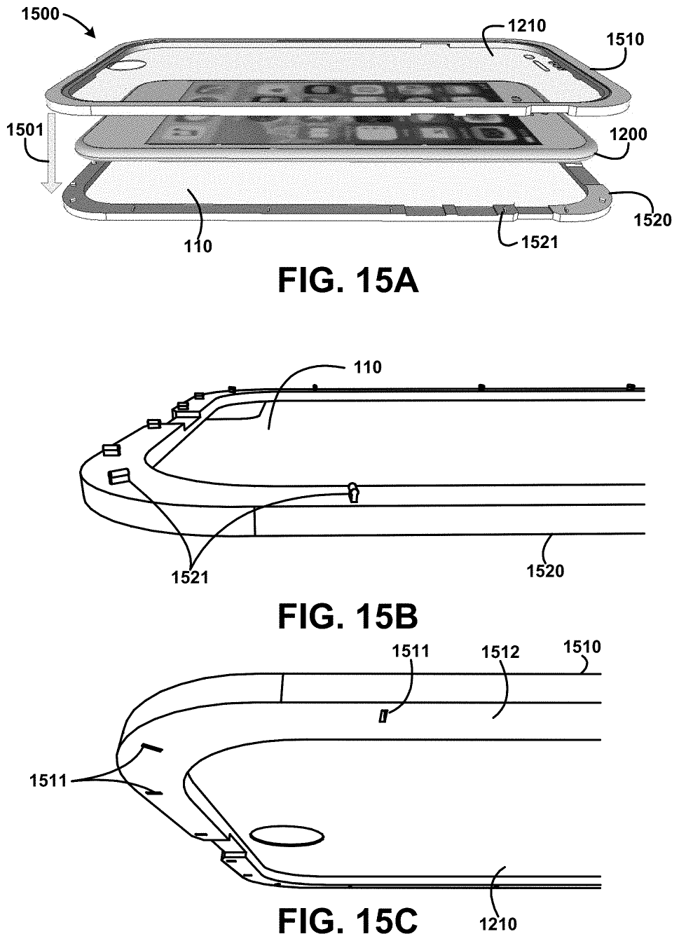

FIG. 15A shows for illustrative purposes only an example of a top and bottom two-part snap together digital device protective case with coupled tempered glass covers of one embodiment. FIG. 15A shows top and bottom two-part snap together digital device protective case with coupled tempered glass covers 1500 oriented above and below a cell phone 1200.

In another embodiment the snap tabs shown represent magnets that allow the sections to be held together magnetically.

The cell phone is lowered into a bottom snap together section 1520. The bottom snap together section 1520 includes a plurality of a snapping tab 1521 and a tempered glass back cover 110 coupled in place of one embodiment.

A top snap together section 1510 includes a plurality of a snapping tab receptacle 1511 shown in FIG. 15C and a tempered glass front cover 1210 coupled in place. The top snap together section 1510 is lowered 1501 onto the bottom snap together section 1520 and aligned with the plurality of a snapping tab 1521. A user applies pressure to push the snapping tabs into the snapping tab receptacles. The top and bottom two-part snap together digital device protective case with coupled tempered glass covers 1500 includes air cushion compartments in the body of the two-parts of the digital device protective case not shown. Coupling of a front or back tempered glass cover to the two-part snap together digital device protective case or other embodiment of the digital device protective case 100 may include for example an adhesive material for example a glue or other adhesive material or a mechanical means for example a plurality of retention tabs or other mechanical means of one embodiment.

### Bottom Section of a Two-Part Snap Together Digital Device Protective Case:

FIG. 15B shows for illustrative purposes only an example of a bottom section of a two-part snap together digital device protective case with a coupled tempered glass back cover of one embodiment. FIG. 15B shows a bottom section of a two-part snap together digital device protective case 1520 with a coupled tempered glass back cover 110 and a plurality of a snapping tab 1521 of one embodiment.

### Top Section of a Two-Part Snap Together Digital Device Protective Case:

FIG. 15C shows for illustrative purposes only an example of a top section of a two-part snap together digital device protective case with a coupled tempered glass front cover of one embodiment. FIG. 15C shows a top section of a two-part snap together digital device protective case 1510 with a coupled tempered glass front cover 1210 and a plurality of a snapping tab receptacle 1511 on the mating face 1512 of the top section of a two-part snap together digital device protective case 1510. The snapping tab receptacle 1511 is recessed into the mating face 1512 and is configured to accept the snapping tab 1521 and snap the two-parts together. The two-parts can be pried apart to remove the cell phone 1200 of one embodiment.

### Embedded Magnets Digital Device Protective Case:

In one embodiment the two-part digital device protective case 100 includes a plurality of magnets embedded into the matching bumper surfaces. The embedded magnets are configured to have positive and negative polarities on opposing surface positions allowing the magnet attraction of the poles to hold the two-part digital device protective case 100 together of one embodiment

### Two-Part Slide and Snap Together Digital Device Protective Case:

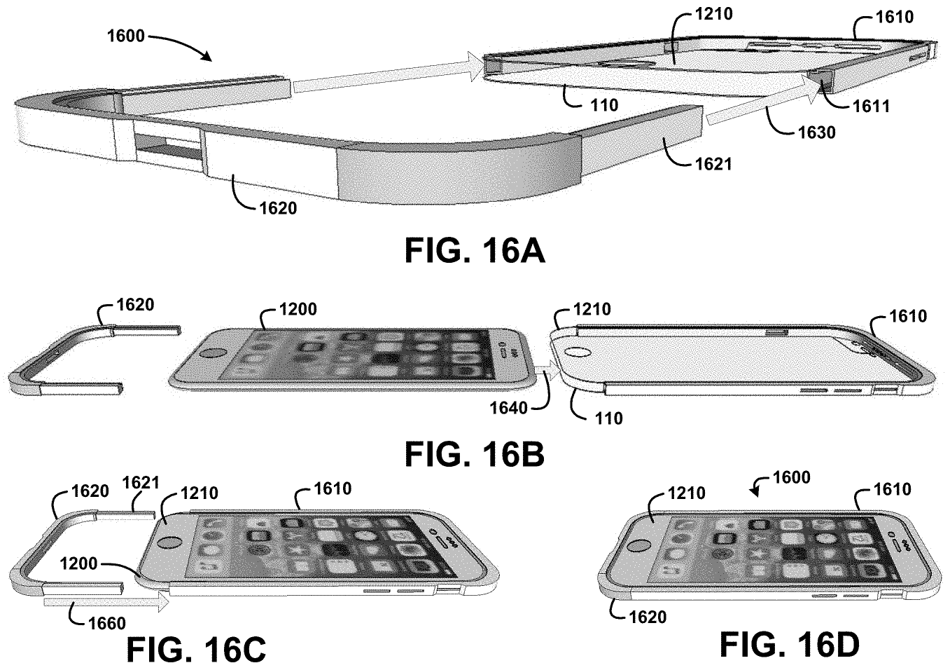

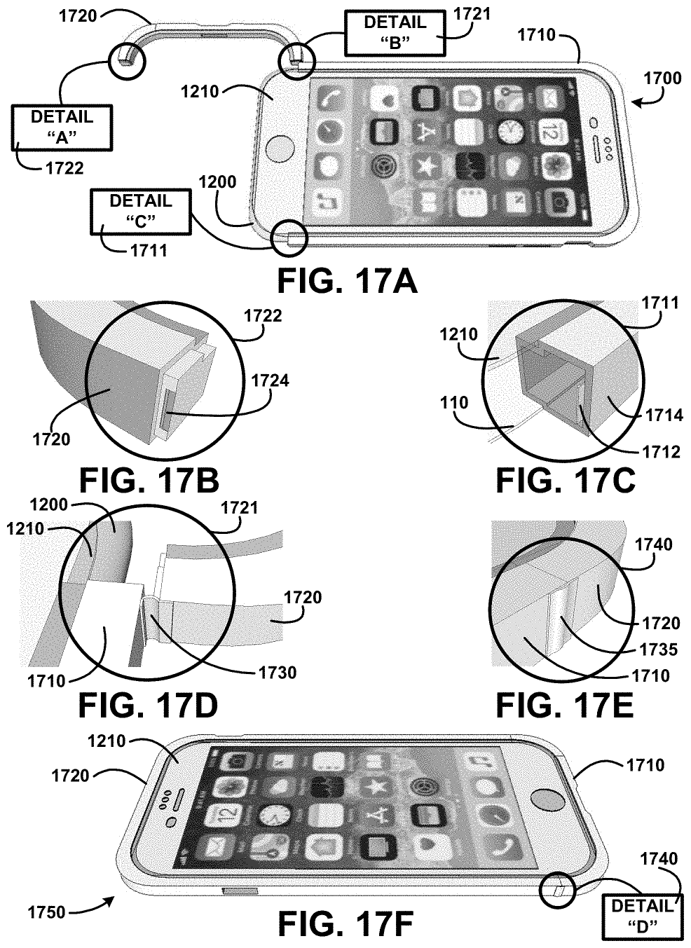

FIG. 16A shows for illustrative purposes only an example of a two-part slide and snap together digital device protective case with glued tempered glass covers of one embodiment. FIG. 16A shows a two-part slide and snap together digital device protective case with glued tempered glass covers 1600 including a slide receiver section 1610 including hollowed slider shaft channels 1611 and a tempered glass back cover 110 and a tempered glass front cover 1210 both of which are glued to the slide receiver section 1610 of one embodiment.

A slider section 1620 includes a slider shaft extension 1621 on both sides that are configured to slide into 1630 the hollowed slider shaft channels 1611 and snap in place using a snapping tab and receptacle not shown. Each slider shaft extension 1621 is aligned with the corresponding the hollowed slider shaft channel 1611 and the slider section 1620 is pushed towards the slide receiver section 1610 until the two section parts snap together. The two-part slide and snap together digital device protective case with glued tempered glass covers 1600 includes air cushion compartments in the body of the digital device protective case not entirely shown of one embodiment.

Cell Phone Insertion into a Receiver Section:

FIG. 16B shows for illustrative purposes only an example of a cell phone insertion into a slide receiver section of a two-part slide and snap together digital device protective case with glued tempered glass covers of one embodiment. FIG. 16B shows a cell phone 1200 insertion 1640 into a slide receiver section 1610 between the tempered glass back cover 110 and a tempered glass front cover 1210 of one embodiment.

Sliding a Bottom Section into a Receiver Section:

FIG. 16C shows for illustrative purposes only an example of sliding a slider section into a receiver section of a two-part slide and snap together digital device protective case with glued tempered glass covers of one embodiment. FIG. 16C shows the slide receiver section 1610 and a tempered glass front cover 1210 glued to the slide receiver section 1610. A slider section 1620 includes a slider shaft extension 1621 on both sides. When the cell phone 1200 is inserted the slider section 1620 is aligned and pushed to slide the slider shaft extension 1660 into the slide receiver section 1610 and snap locked in place of one embodiment.

### Cell Phone Installed in a Two-Part Slide and Snap Together Digital Device Protective Case:

FIG. 16D shows for illustrative purposes only an example of a cell phone installed in a two-part slide and snap together digital device protective case with glued tempered glass covers of one embodiment. FIG. 16D shows the cell phone 1200 of FIG. 12A installed in a two-part slide and snap together digital device protective case with glued tempered glass covers 1600 after the slide receiver section 1610 and the slider section 1620 have been mated and slid together of one embodiment.

Digital Device Protective Case with a Hinged Snap Section:

FIG. 17A shows for illustrative purposes only an example of a digital device protective case with glued tempered glass covers with a hinged snap section of one embodiment. FIG. 17A shows a digital device protective case with glued tempered glass covers with a hinged snap section 1700. The digital device protective case with glued tempered glass covers with a hinged snap section 1700 can be configured with a hinged snap section 1720 at one end of the digital device protective case or the other. A hinged receiver section 1710 includes a tempered glass front cover 1210 and a tempered glass back cover 110 of FIG. 1 glued to the digital device protective case of one embodiment.

A cell phone 1200 is inserted into the hinged receiver section 1710 between the glued in position tempered glass front cover 1210 and a tempered glass back cover 110 of FIG. 1. The hinged snap section 1720 includes a flexible hinge coupled to both the hinged snap section 1720 and hinged receiver section 1710 as shown in Detail “B” 1721 and Detail “D” of FIGS. 17D-F. The hinged snap section 1720 includes a snap tab receiver 1724 as shown in Detail “A” 1722. The hinged receiver section 1710 includes a snap tab 1712 as shown in Detail “C” 1711. The digital device protective case with glued tempered glass covers with a hinged snap section 1700 includes air cushion compartments in the body of the digital device protective case sections not shown of one embodiment.

### Hinged Snap Section Snap Lock Receptacle:

FIG. 17B shows for illustrative purposes only an example of a hinged snap section snap lock receptacle of one embodiment. FIG. 17B shows Detail “A” 1722 including one hinged end of the hinged snap section 1720 and the snap lock receptacle 1724 of one embodiment.

### Hinged Receiver Section Snap Lock Tab:

FIG. 17C shows for illustrative purposes only an example of a digital device protective case with glued tempered glass covers receiver section snap lock tab of one embodiment. FIG. 17C shows Detail “C” 1711 including a hinged side of the hinged receiver section 1710 includes a tempered glass front cover 1210 and a tempered glass back cover 110 of FIG. 1 glued to the digital device protective case. Also shown is the hollow air cushion compartment 1714 with a snap tab lock 1712 coupled on the outer inside surface of one embodiment.

### Hinge in an Opened Position:

FIG. 17D shows for illustrative purposes only an example of a hinged snap section hinge in an opened position of one embodiment. FIG. 17D shows Detail “B” 1721 including a flexible hinge in an opened position 1730 coupled to both the hinged snap section 1720 and hinged receiver section 1710. The hinged receiver section 1710 includes the glued in position tempered glass front cover 1210 and a tempered glass back cover 110 of FIG. 1 of one embodiment.

### Hinge in a Closed Position:

FIG. 17E shows for illustrative purposes only an example of a hinged snap section hinge in a closed position of one embodiment. FIG. 17E shows Detail “D” 1740 including a flexible hinge in a closed position 1735 coupled to both the hinged snap section 1720 and hinged receiver section 1710 of one embodiment.

Cell Phone Installed in a Digital Device Protective Case with a Hinged Snap Section:

FIG. 17F shows for illustrative purposes only an example of a cell phone installed in a digital device protective case with glued tempered glass covers with a hinged snap section of one embodiment. FIG. 17F shows a cell phone installed in a digital device protective case with glued tempered glass covers with a hinged snap section 1750. The tempered glass front cover 1210 is shown glued in position on the hinged receiver section. Detail “D” 1740 is shown in more detail in FIG. 17E. The hinged snap section 1720 and hinged receiver section 1710 are shown in a closed hinged position and snap locked with the cell phone 1200 of FIG. 12A installed of one embodiment.

### Liquid Glass Protector Paddle Applicator Cleaning Process:

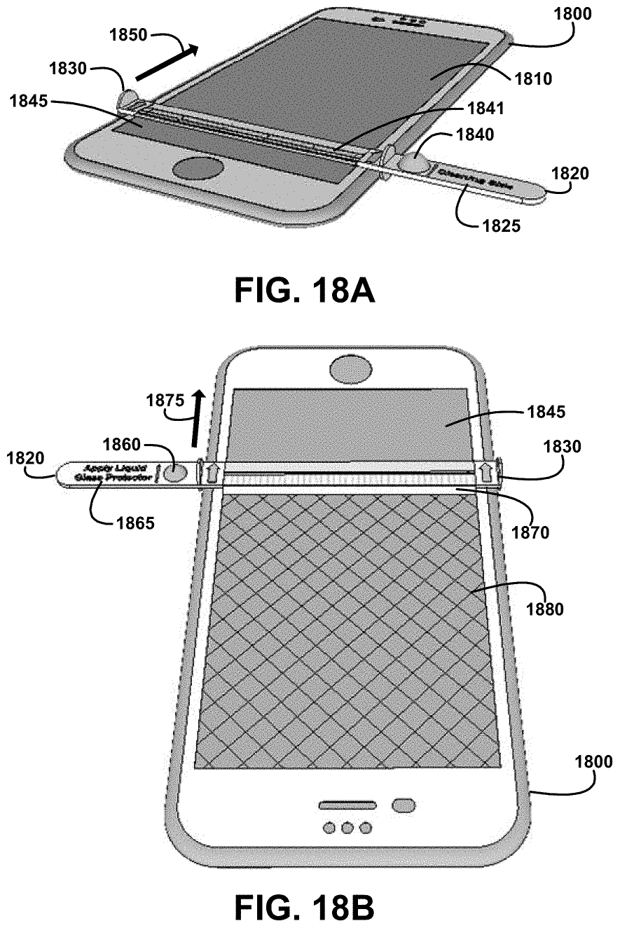

FIG. 18A shows a block diagram of an overview of liquid glass protector paddle applicator cleaning process of one embodiment. FIG. 18A shows a digital device cell phone 1800 with a cell phone glass screen 1810. Also showing is a liquid glass protector paddle applicator 1820. The liquid glass protector paddle applicator 1820 is configured to include a cleaning side 1825, cell phone applicator guide 1830, a cleaner reservoir and pump 1840 and a liquid glass wipe material 1841. The user may push or not push the cleaner reservoir and pump 1840 in order to prevent excessive fluid from accumulating in advance of the movement of the liquid glass protector paddle applicator 1820. The liquid glass protector paddle applicator 1820 cleaning side 1825 is used to produce a cleaned cell phone glass screen surface 1845 as it is used in a cleaning movement direction 1850 in preparation for applying a liquid glass protector application of one embodiment.

### Liquid Glass Protector Paddle Applicator Application Process:

FIG. 18B shows a block diagram of an overview of liquid glass protector paddle applicator application process of one embodiment. FIG. 18B shows the digital device cell phone 1800 with a cleaned cell phone glass screen surface 1845 ready to apply liquid glass protector 1865 on the cleaned surface. The liquid glass protector paddle applicator 1820 is configured to include a liquid glass reservoir and pump 1860. When pushed by a user it pumps the liquid glass suspension solution onto the cleaned cell phone glass screen surface 1845 as the liquid glass protector paddle applicator 1820 is moved in a liquid glass protector application direction 1875. The movement of the liquid glass protector paddle applicator 1820 follows a path using a cell phone applicator guide 1830 on each side of the digital device cell phone 1800. A first liquid glass screed 1870 regulates the thickness of the liquid glass as the movement of the liquid glass protector paddle applicator 1820 travels down the length of the digital device cell phone 1800. The screed regulated liquid glass dries to produce a liquid glass protector 1880 shown as a hatched pattern for illustration only.

It should be noted that while the example of applying a liquid glass protector is shown for application on a cell phone screen and that applying a liquid glass protector is applicable to applying a liquid glass protector to a cell phone glass back cover. It should be further noted that applying a liquid glass protector is also applicable for application on other electronic devices. The liquid glass protector application process is also for use on electronic devices including but not limited to for example an Apple Watch, iPad, digital tablet, laptop computer and other electronic devices. This inclusion also includes coupling the other electronic devices with the applied liquid glass protector to a digital device protective case 100 configured for that electronic device without a tempered glass cover 1441 of FIG. 14C. Also for example coupling the other electronic devices with the applied liquid glass protector to a digital device protective case 100 configured for that electronic device wherein the digital device protective case 100 includes at least one tempered glass cover 1441 of FIG. 14C of one embodiment.

### Liquid Glass Protector Paddle Applicator Cleaning Side:

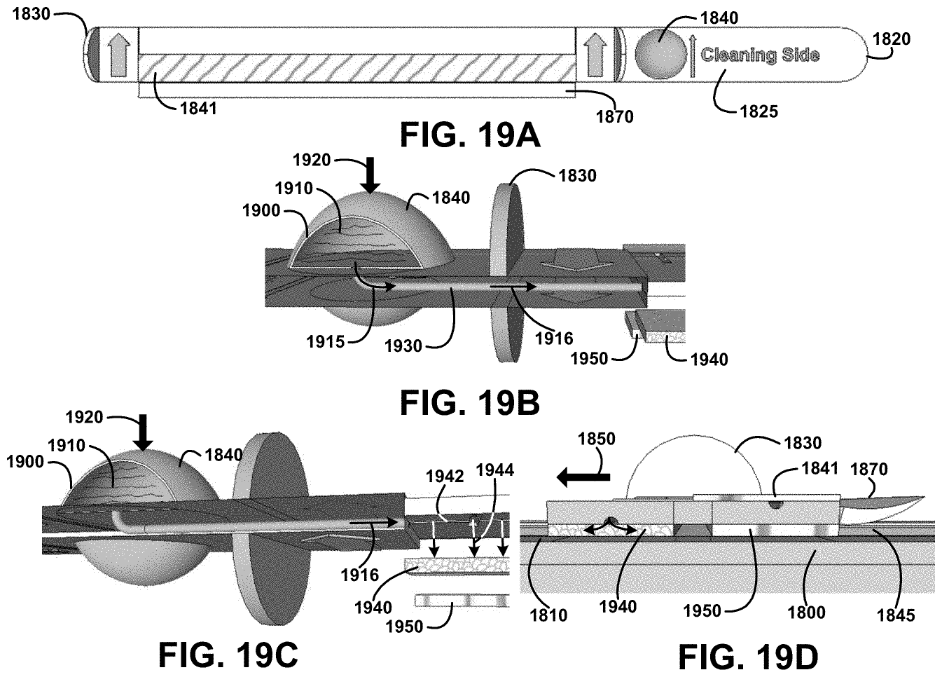

FIG. 19A shows a block diagram of an overview of liquid glass protector paddle applicator cleaning side of one embodiment. FIG. 19A shows the liquid glass protector paddle applicator 1820 cleaning side 1825 including the cell phone applicator guide 1830, cleaner reservoir and pump 1840, a liquid glass wipe material 1841 and first liquid glass screed 1870 of one embodiment.

### Cleaning Fluid Reservoir and Pump:

FIG. 19B shows a block diagram of an overview of cleaning fluid reservoir and pump of one embodiment. FIG. 19B shows the cell phone applicator guide 1830 and cleaner reservoir and pump 1840. FIG. 19B shows a cut-away of the cleaner reservoir and pump 1900 to expose a cleaner fluid filling the cleaner reservoir and pump 1910. With pressure applied by a user 1920 pressurized cleaner fluid flows out of reservoir 1915 through a cleaner fluid flow tube 1930. Pressurized cleaner fluid flows through cleaner fluid flow tube 1916 to a cleaning sponge 1940 coupled to the liquid glass protector paddle applicator 1820 of FIG. 18A. Coupled adjacent to the cleaning sponge 1940 is a cleaner wipe material 1950 of one embodiment.

### Cleaning Fluid Pressured Flow to Sponge:

FIG. 19C shows for illustrative purposes only an example of cleaning fluid pressured flow to sponge of one embodiment. FIG. 19C shows the cleaner reservoir and pump 1840. The cut-away of cleaner reservoir and pump 1900 reveals the cleaner fluid filling cleaner reservoir and pump 1910. The cleaner fluid filling cleaner reservoir and pump 1910 with pressure applied by a user 1920 the cleaner fluid travels down a half tube canal 1942 and the cleaner fluid soaks into the cleaner sponge 1944. The cleaning sponge 1940 wipes the surface of the cell phone glass screen 1810 of FIG. 18A to remove finger marks, any particulates and oil from the finger marks.

The cleaner wipe material 1950 soaks up excess cleaner fluid and further removes any residual contaminates. The cleaner fluid is a solution that will cut any oil and dries rapidly for the application process of the liquid glass. The cleaner wipe material 1950 may be a soft absorbent fabric including an absorbent shammy. The cleaning sponge 1940 includes fine celled foam to prevent any scratching of one embodiment.

### Cleaning and Wiping Process:

FIG. 19D shows for illustrative purposes only an example of cleaning and wiping process of one embodiment. FIG. 19D shows the liquid glass protector paddle applicator 1820 of FIG. 18A in the cleaning movement direction 1850 using the cell phone applicator guide 1830 for path guidance. The first liquid glass screed 1870 is shown on top with the liquid glass wipe material 1841. The cell phone glass screen 1810 of the digital device cell phone 1800 to be cleaned is ahead of the cleaning sponge 1940 soaked with cleaning fluid flowing from the half tube canal 1942. The cleaning sponge 1940 cleans the surface with the cleaning fluid and scrubs the surface. The cleaner wipe material 1950 further wipes the surface clean while absorbing excess cleaning fluid leaving the cleaned cell phone glass screen surface 1845 of one embodiment.

### Liquid Glass Protector Paddle Applicator Applying Side:

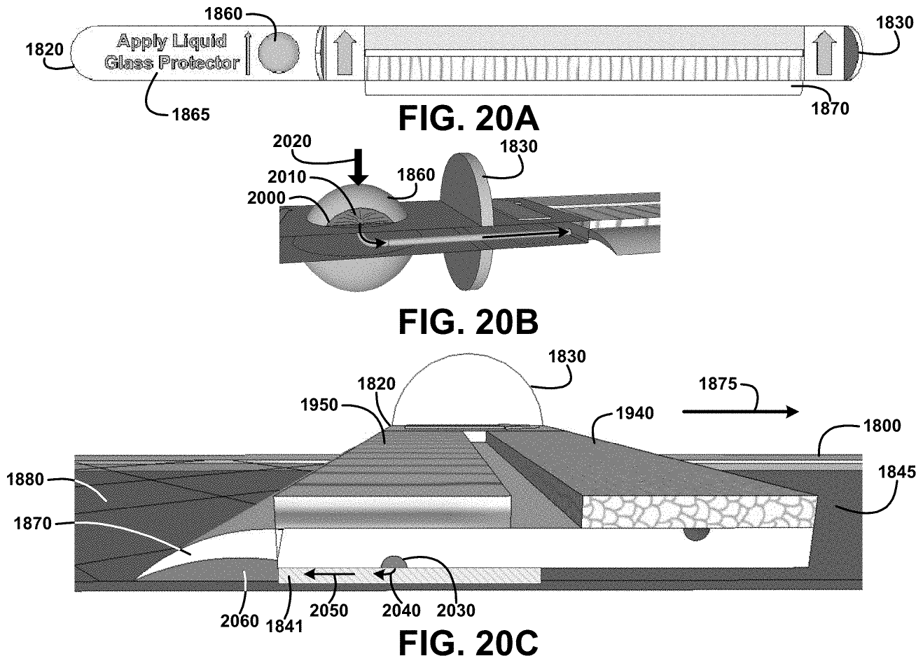

FIG. 20A shows for illustrative purposes only an example of liquid glass protector paddle applicator applying side of one embodiment. FIG. 20A shows the liquid glass protector paddle applicator 1820 with the cell phone applicator guide 1830 and liquid glass reservoir and pump 1860. The liquid glass protector paddle applicator 1820 is oriented to apply liquid glass protector 1865 using the first liquid glass screed 1870 to the digital device cell phone 1800 of FIG. 18A with a cell phone glass screen 1810 of FIG. 18A of one embodiment.

### Liquid Glass Suspension Reservoir and Pump:

FIG. 20B shows for illustrative purposes only an example of liquid glass suspension reservoir and pump of one embodiment. FIG. 20B shows the cell phone applicator guide 1830 and liquid glass reservoir and pump 1860. Also showing is a cut-away of the liquid glass reservoir and pump 2000. The cut-away of the liquid glass reservoir and pump 2000 reveals a liquid glass suspension in a solvent solution filling the liquid glass reservoir 2010. Pressure applied by a user to the liquid glass reservoir and pump 2020 pumps the liquid glass suspension through tubes to the surface of the digital device cell phone 1800 of FIG. 18A with a cell phone glass screen 1810 of FIG. 18A of one embodiment.

The liquid glass protector 1880 is based on liquid glass (SiO₂) nanotechnology. The coating is effectively tiny particles of glass (silica) suspended in a solvent. Once applied the coating is thin, yet it can dramatically increase the hardness and durability for coated screen. The coating is applied by embedding the glass particles onto the glass substrate. The solvent then evaporates, and the glass particles remain.

Silica Dioxide or SiO₂ comes in many forms and one of those forms is called Liquid Glass. SiO₂ is essentially microscopic particles of glass and Liquid Glass is those particles suspended in a liquid solution, including a solvent solution. The molecules of glass (silicon dioxide/SiO₂) come from pure quartz sand, of which there are vast reserves, as silicon dioxide is one of the most abundant compounds on the planet. Just like domestic glass, liquid glass coatings are food safe, chemically inert and highly resistant to commonly used cleaning chemicals. The coatings also offer resistance to alkalis, acids and solvents of one embodiment.

### Liquid Glass Application Process:

FIG. 20C shows for illustrative purposes only an example of liquid glass application process of one embodiment. FIG. 20C shows the liquid glass protector paddle applicator 1820 with the cell phone applicator guide 1830 guiding the applicator along liquid glass protector application direction 1875. The digital device cell phone 1800 cleaned cell phone glass screen surface 1845 is in the path of the liquid glass protector paddle applicator 1820 liquid glass application. The cleaning sponge 1940 and cleaner wipe material 1950 can be seen on top.

The liquid glass flowing into and being absorbed by the liquid glass wipe material 1841 from the liquid glass half tube canal 2030 and comes in contact with the cell phone cleaned glass 2040. The flowing liquid glass puddles 2050 in front of the moving first liquid glass screed 1870. Liquid glass is thinned by the first liquid glass screed 2060. The thinned liquid glass dries quickly forming the liquid glass protector 1880 on the cell phone glass screen 1810 of FIG. 18A. The liquid glass protector 1880 is anti-bacterial, scratch resistant, improves the screen's strength and impact resistance and improves clarity of the screen of one embodiment.

### Digital Device Protective Case and Cell Phone Screen Spray Cleaning Process:

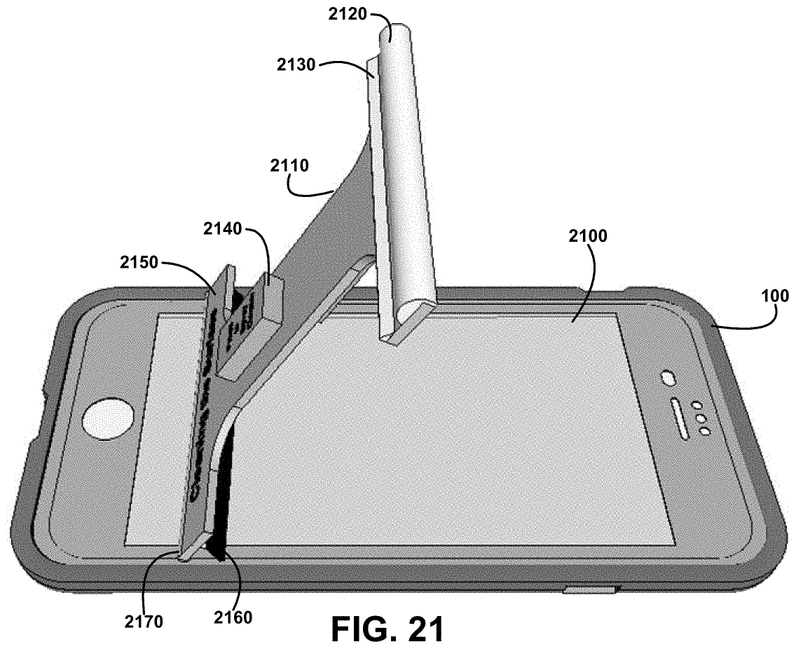

FIG. 21 shows for illustrative purposes only an example of digital device protective case and cell phone screen spray cleaning process of one embodiment. FIG. 21 shows the digital device protective case 100 surrounding a digital device with a digital device glass screen 2100. A liquid glass protector spray applicator 2110 with a second liquid glass screed 2120, liquid glass spray manifold 2130, cleaner fluid cube reservoir and pump 2140, cleaning the surface applicator end 2150 and spray cleaning wipe material 2160. The second liquid glass screed 2120 may be made of a plastic, or brush device or a cloth or a piece of paper or a wipe material. The liquid glass protector spray applicator 2110 produces a cleaning fluid spray 2170 for cleaning a digital device glass screen 2100 in preparation for applying liquid glass of one embodiment.

### Digital Device Protective Case and Cell Phone Screen Spray Liquid Glass Protector Application Process:

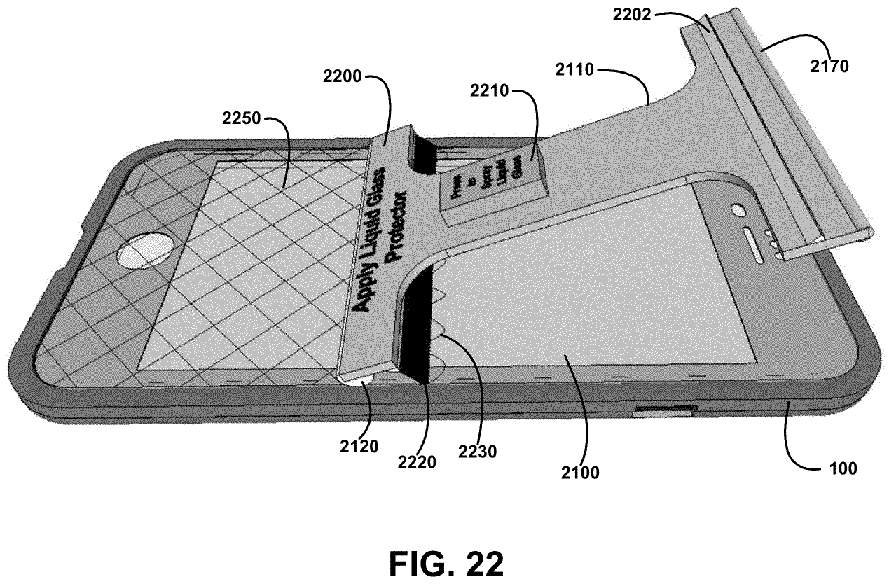

FIG. 22 shows for illustrative purposes only an example of digital device protective case and cell phone screen spray liquid glass protector application process of one embodiment. FIG. 22 shows the digital device protective case 100 and digital device glass screen 2100. The liquid glass protector spray applicator 2110 includes a cleaner fluid spray manifold 2202 and cleaning wipe material 2170. A liquid glass application end of liquid glass protector spray applicator 2200 is configured to include a liquid glass cube reservoir and pump 2210 producing a liquid glass spray 2220. The user may push or not push the liquid glass cube reservoir and pump 2210 or cleaner fluid cube reservoir and pump 2140 of FIG. 21 in order to prevent excessive fluid from accumulating in advance of the movement of the liquid glass protector spray applicator 2110 during the cleaning or liquid glass application processes.

The liquid glass spray 2220 creates pooling liquid glass spray 2230 that is processed by a second liquid glass screed 2120 for thinning. The thinned liquid glass dries quickly forming a spray applied liquid glass protector 2250 on the digital device glass screen 2100 enclosed in the digital device protective case 100 of one embodiment.

### Digital Device Protective Case Glass Screen Protector Cleaning Process:

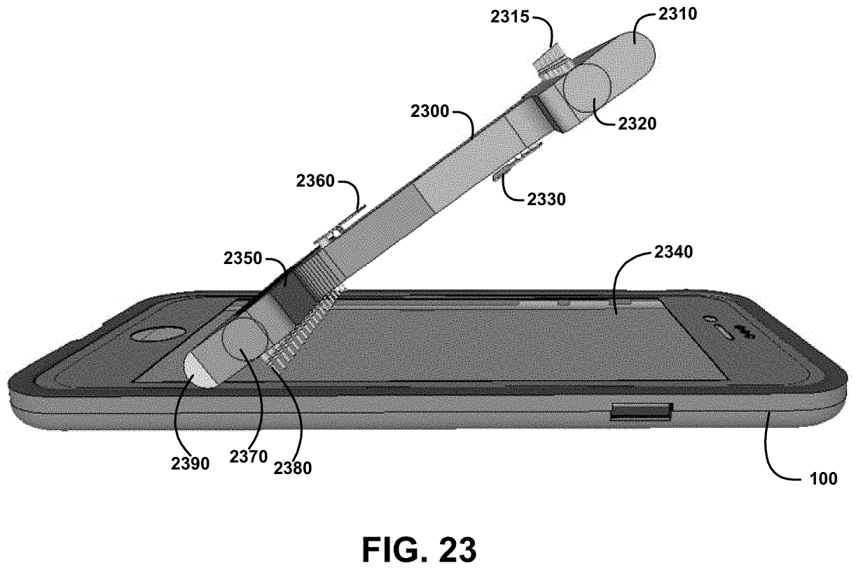

FIG. 23 shows for illustrative purposes only an example of digital device protective case glass screen protector cleaning process of one embodiment. FIG. 23 shows the digital device protective case 100 with a glass screen protector.

The digital device protective case 100 glass screen protector may be made of regular glass or tempered glass. The liquid glass application may be applied to a digital device protective case 100 with a regular glass screen protector to strength the regular glass against breakage, cracking and scratching. The liquid glass application may be applied to a digital device protective case 100 with a tempered glass screen protector to strength the regular glass against breakage, cracking and scratching.

Applications of liquid glass may include using a dropper to deposit drops of liquid glass onto a screen protector glass surface. The deposited drops may be spread using a brush or a cloth or a piece of paper. In another embodiment the liquid glass may be absorbed into a wipe material and spread onto the screen protector glass surface using the wipe material with the absorbed liquid glass solution and let it dry.

On the digital device protective case glass screen protector 2340 is a drip flow liquid glass protector applicator 2300. The drip flow liquid glass protector applicator 2300 is configured with a third liquid glass screed 2310, liquid glass drip droppers 2315, liquid glass suspension cylindrical reservoir 2320, liquid glass vacuum release device 2330, cleaning end of the drip flow liquid glass protector applicator 2350, cleaning fluid vacuum release device 2360, cleaning fluid cylindrical reservoir 2370, cleaning fluid droppers 2380, and drip cleaning fluid wipe material 2390. The third liquid glass screed 2310 may be made of a plastic, or brush device or a cloth or a piece of paper or a wipe material of one embodiment.

### Digital Device Protective Case Glass Screen Protector Drip Cleaning Process Isometric View:

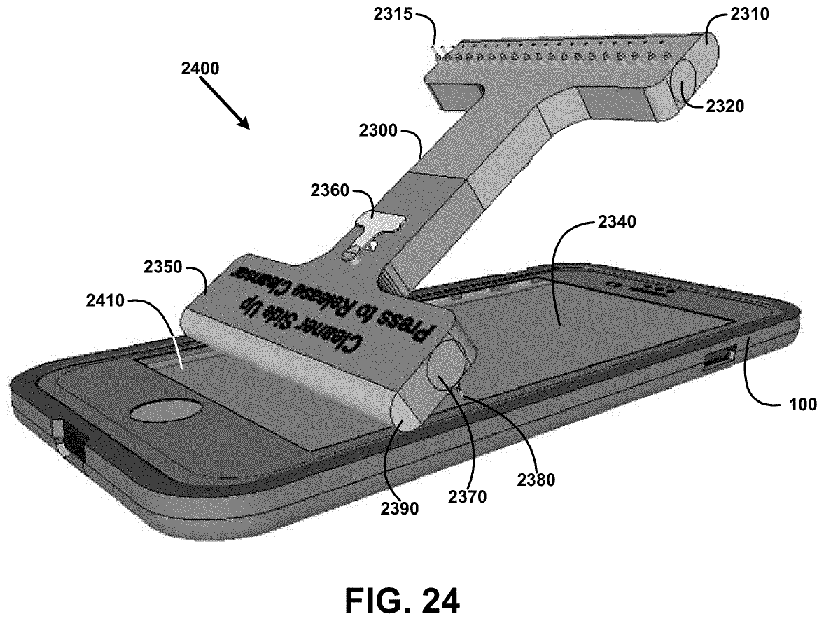

FIG. 24 shows for illustrative purposes only an example of digital device protective case glass screen protector drip cleaning process isometric view of one embodiment. FIG. 24 shows a process for cleaning the digital device protective case glass screen protector 2400 coupled to the digital device protective case 100. The digital device protective case glass screen protector 2340 is being cleaned using the drip flow liquid glass protector applicator 2300. The cleaning end of the drip flow liquid glass protector applicator 2350 uses pressure on the cleaning fluid vacuum release device 2360 handle to pull out a stopper on an air vent coupled to the cleaning fluid cylindrical reservoir 2370. Pulling out the stopper allows air to enter the vent pipe opening and thereby breaking the vacuum of the cleaning fluid cylindrical reservoir 2370 allowing cleaning fluid to flow through the cleaning fluid droppers 2380 and begin dripping onto the digital device protective case glass screen protector 2340.

The dripping cleaning fluid from the plurality of cleaning fluid droppers 2380 pool on the surface and begins dissolving for example finger oils and other materials adhering to the surface of the digital device protective case glass screen protector 2340 surface. As a user pulls the drip flow liquid glass protector applicator 2350 across the surface the drip cleaning fluid wipe material 2390 wipes off the finger oils and other materials and absorbs any excess cleaning fluid. The wiped surface produces a cleaned digital device protective case glass screen protector 2410 in preparation for applying liquid glass. The drip flow liquid glass protector applicator 2300 also includes a third liquid glass screed 2310, liquid glass drip droppers 2315 and a liquid glass suspension cylindrical reservoir 2320 of one embodiment.

### Liquid Glass Vacuum Release Device:

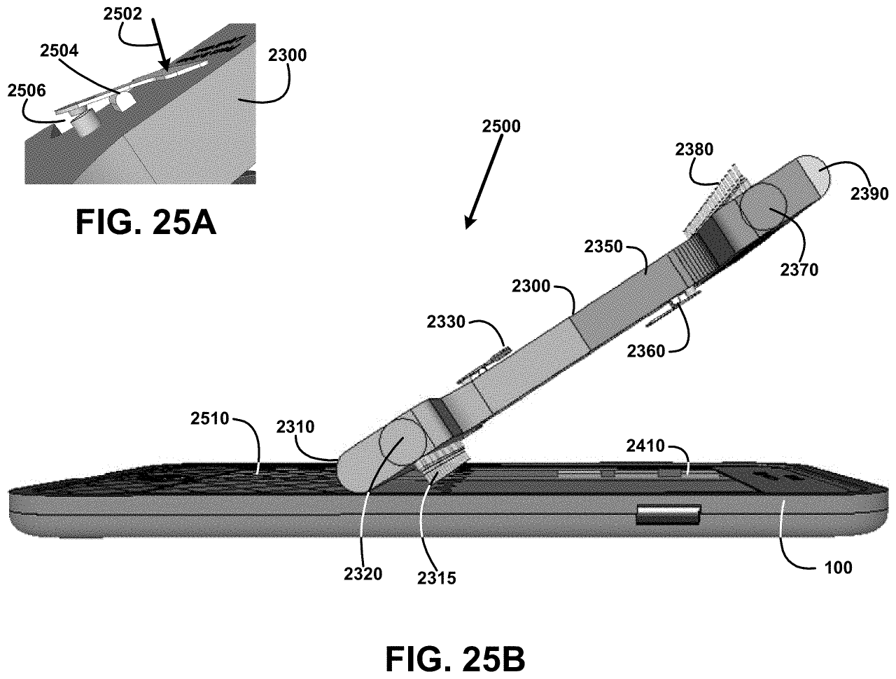

FIG. 25A shows for illustrative purposes only an example of liquid glass vacuum release device of one embodiment. FIG. 25A shows a close up of the drip flow liquid glass protector applicator 2300 and liquid glass vacuum release device 2330 of FIG. 23. A liquid glass vacuum release toggle 2502 is pushed down by a user wherein a liquid glass vacuum release pivot 2504 causes a levered force to release a liquid glass vacuum release stopper 2506 from the air vent coupled to a cylindrical reservoir of cleaning fluid or liquid glass. Pulling out the stopper allows air to enter the vent pipe opening and thereby breaking the vacuum of the cylindrical reservoir allowing cleaning fluid or liquid glass to flow through the cleaning fluid droppers 2380. A user may pull out the stopper to allow flow of a fluid and may close the stopper to stop the flow of the fluid. In this way a user may prevent excessive fluid from flowing onto the surface in advance of the drip flow liquid glass protector applicator 2300 of FIG. 23 movement of one embodiment.

### Digital Device Protective Case Glass Screen Protector Drip Liquid Glass Protector Application Process:

FIG. 25B shows for illustrative purposes only an example of digital device protective case glass screen protector drip liquid glass protector application process of one embodiment. FIG. 25B shows applying the liquid glass to the cleaned digital device protective case glass screen protector 2500 of the digital device protective case 100. The digital device protective case glass screen protector 2410 has been cleaned using the cleaning end of drip flow liquid glass protector applicator 2350 with the cleaning fluid vacuum release device 2360, cleaning fluid cylindrical reservoir 2370, cleaning fluid droppers 2380 and drip cleaning fluid wipe material 2390.

The drip flow liquid glass protector applicator 2300 includes a liquid glass application end. The liquid glass application end includes the third liquid glass screed 2310, liquid glass drip droppers 2315, and liquid glass suspension cylindrical reservoir 2320 to create a drip applied liquid glass protector 2510 of one embodiment.

### Digital Device Protective Case Glass Screen Protector Drip Liquid Glass Protector Application Process Isometric View:

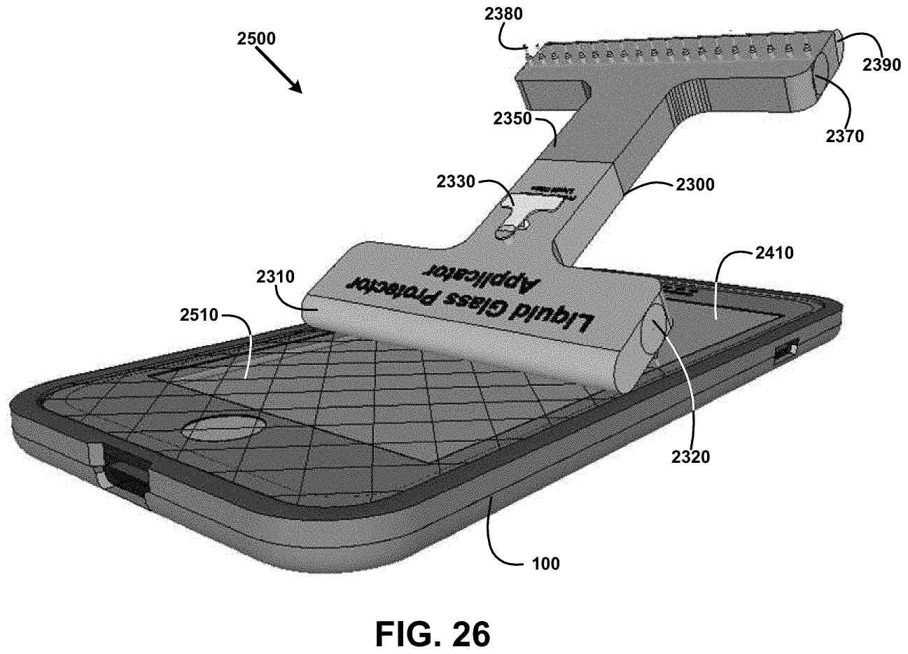

FIG. 26 shows for illustrative purposes only an example of digital device protective case glass screen protector drip liquid glass protector application process isometric view of one embodiment. FIG. 26 shows applying the liquid glass to the cleaned digital device protective case glass screen protector 2500 of the digital device protective case 100. In a previous process the cleaning end of drip flow liquid glass protector applicator 2350 with the cleaning fluid cylindrical reservoir 2370, cleaning fluid droppers 2380 and drip cleaning fluid wipe material 2390 was used to produce the cleaned digital device protective case glass screen protector 2410. The drip flow liquid glass protector applicator 2300 using the liquid glass suspension cylindrical reservoir 2320 and third liquid glass screed 2310 are now used to create a drip applied liquid glass protector 2510 of one embodiment.

### Liquid Glass Sodium Dioxide Molecules:

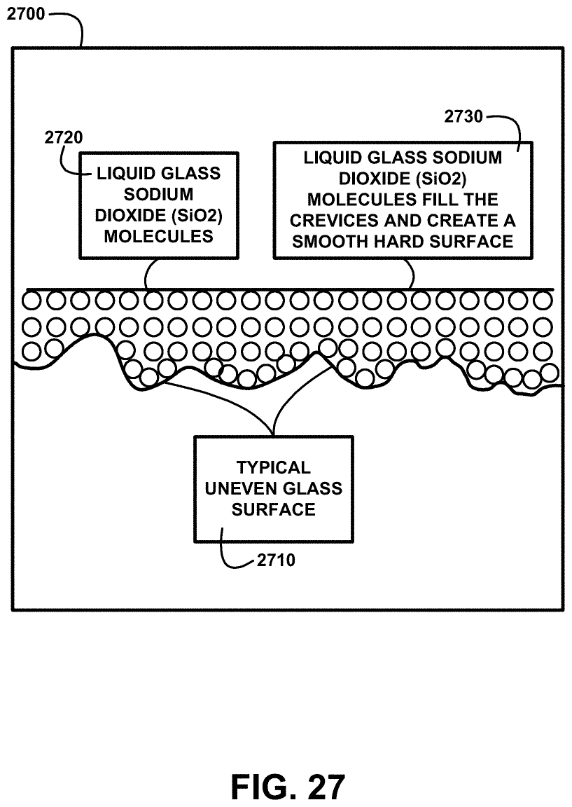

FIG. 27 shows for illustrative purposes only an example of liquid glass sodium dioxide molecules of one embodiment. FIG. 27 shows a liquid glass protector application result 2700. Glass is produced in many types, however most glass has a typical uneven glass surface 2710 when viewed at a molecular nano scale level. The liquid glass protector processes use liquid glass sodium dioxide (SiO₂) molecules 2720 at a nano scale to apply to typical glass surfaces. Liquid glass sodium dioxide (SiO₂) molecules fill the crevices of the typical glass uneven surface and create a smooth hard surface 2730 when dried. The crevices of the typical uneven glass surface 2710 weaken the glass and make cracking and breaking more likely to occur when for example dropped and being impacted by an external force. The smooth hard surface created after applying the liquid glass sodium dioxide (SiO₂) molecules 2720 to fill in the typical uneven glass surface 2710 produces a liquid glass protector that is anti-bacterial, scratch resistant, improves the screen's strength and impact resistance and improves clarity of the screen. In addition the liquid glass protector application is used to fix/heal/cover up existing scratches that are on the glass surface of the electronic device of one embodiment.

A Dropper Used to Deposit Liquid Glass onto a Glass Screen Protector:

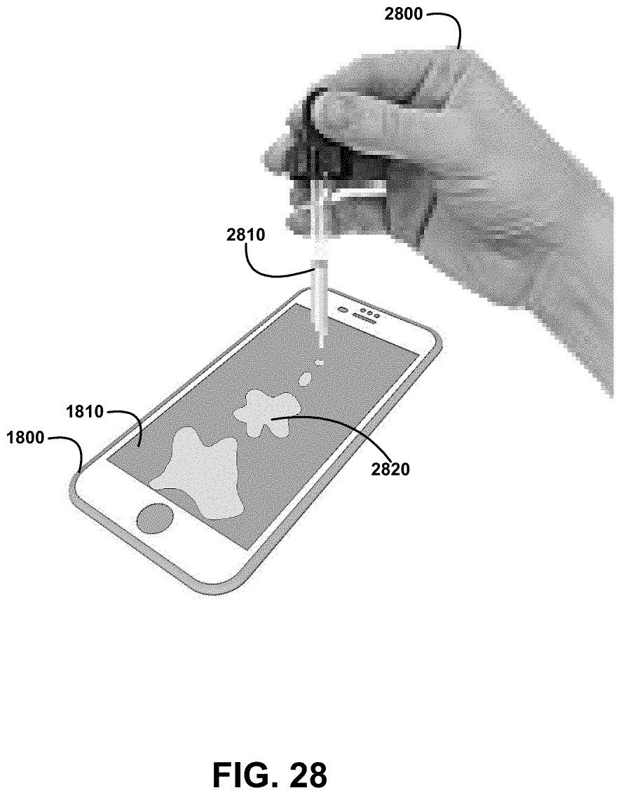

FIG. 28 shows for illustrative purposes only an example of a dropper used to deposit liquid glass onto a glass screen protector of one embodiment. FIG. 28 shows a digital device cell phone 1800 with a cell phone glass screen 1810. A user's hand 2800 is shown squeezing liquid glass from a dropper 2810 onto the cell phone glass screen 1810. The drops are shown pooling on the surface 2820 of the cell phone glass screen 1810. The liquid glass is shown with shading for illustration clarity as the liquid glass is a clear liquid and may not be visible otherwise. The user may place drops of the entire surface area or in partial areas prior to spreading. In another embodiment liquid glass is deposited by spraying the liquid glass onto the cell phone glass screen 1810. In yet another embodiment liquid glass is deposited by pouring from a bottle onto the cell phone glass screen 1810.

### A Cloth to Wipe Liquid Glass Deposited by a Dropper:

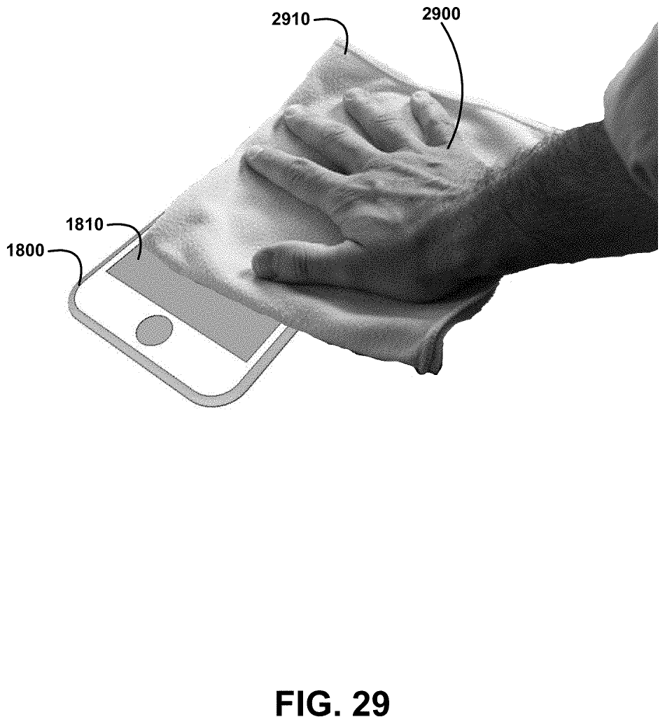

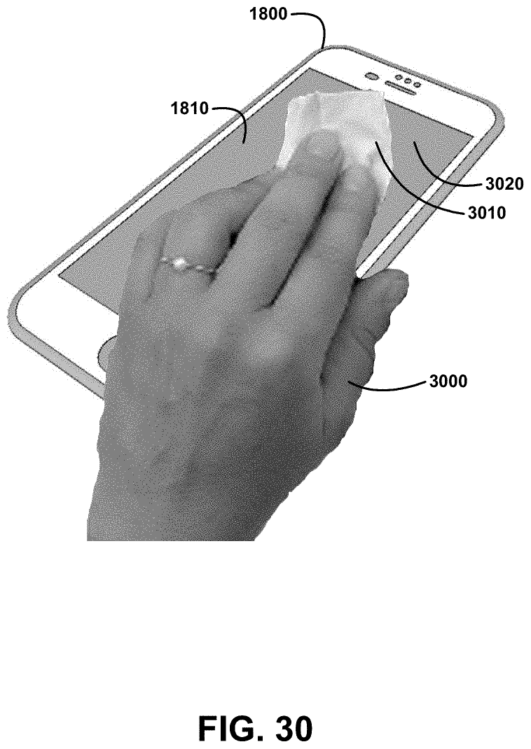

FIG. 29 shows for illustrative purposes only an example of using a cloth to wipe liquid glass deposited by a dropper of one embodiment. FIG. 29 shows a digital device cell phone 1800 with a cell phone glass screen 1810. A user's hand 2900 is shown moving a cloth 2910 over the surface of the cell phone glass screen 1810 to spread the liquid glass over the entire surface when applying the liquid glass protector of one embodiment. In another embodiment a cloth is used to wipe liquid glass deposited by spraying the liquid glass onto the cell phone glass screen 1810 will spread the liquid glass. In yet another embodiment a cloth is used to wipe liquid glass deposited by pouring from a bottle onto the cell phone glass screen 1810 will spread the liquid glass.

Spreading Liquid Glass Using a Wipe with Absorbed Liquid Glass:

FIG. 30 shows for illustrative purposes only an example of spreading liquid glass using a wipe with absorbed liquid glass of one embodiment. FIG. 30 shows a digital device cell phone 1800 with a cell phone glass screen 1810. A user's hand 3000 is shown moving a wipe material towelette 3010 that has liquid glass absorbed into the wipe material towelette 3010 wherein the wipe material towelette with an absorbed liquid glass solution is used to deposit and spread in a wiping process the absorbed liquid glass solution onto and across the entire glass surface forming a liquid glass coating 3020 of one embodiment.

### Four Warranty Plans:

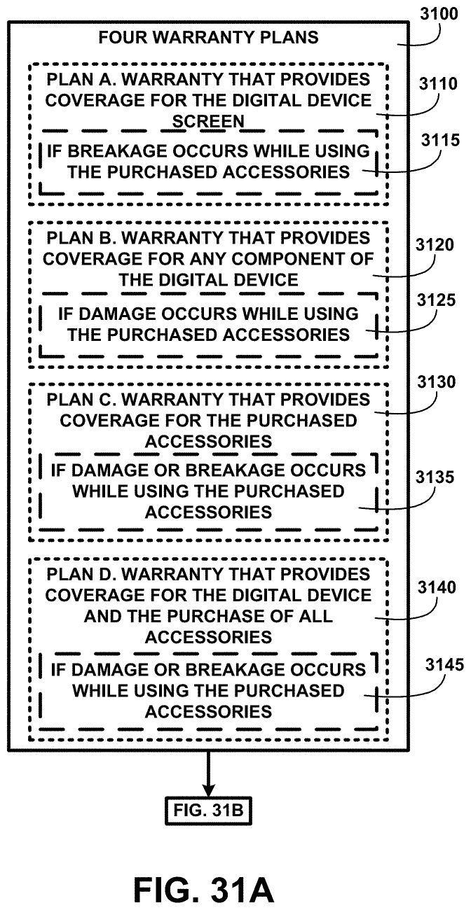

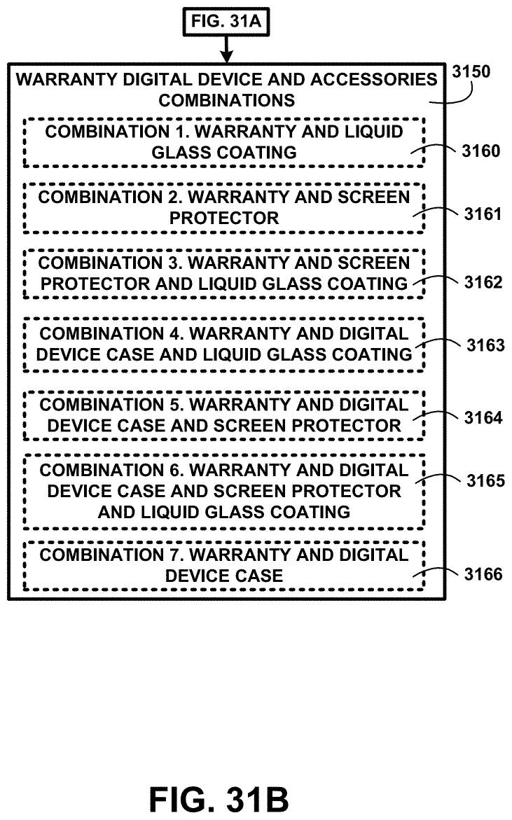

FIG. 31A shows for illustrative purposes only an example of an overview of a four warranty plans of one embodiment. FIG. 31A shows four warranty plans 3100. The four warranty plans 3100 are Plan A. warranty that provides coverage for the digital device screen 3110, if breakage occurs while using the purchased accessories 3115; Plan B. warranty that provides coverage for any component of the digital device 3120, if damage occurs while using the purchased accessories 3125; Plan C. warranty that provides coverage for the purchased accessories 3130, if damage or breakage occurs while using the purchased accessories 3135; and Plan D. Warranty that provides coverage for the digital device and the purchase of all accessories 3140, if damage or breakage occurs while using the purchased accessories 3145.

In another embodiment the warranty plan purchaser also purchases the digital device and at least one of the accessories. In this embodiment each of the warranty plans include coverage of the purchased digital device and the at least one of the accessories purchased.

The warranty plan purchaser can select the coverage they want at the time of purchase of one embodiment. The warranty plan can be purchased later as a stand-alone product that will be associated to a previously purchased combination. So the warranty does not have to be purchased together with the combinations but can be purchased and linked to the order later. A purchaser can go online and order a warranty protection plan for their previous purchase to be combined with the previous purchase. It should be understood that although the drawings and description describe warranty for phones the warranty coverage is also applicable to other devices from a group of devices that can download an application including but not limited to phones, or tablets, or smart watches, or any hand-held devices, or laptops, or desktops of one embodiment. A description of warranty digital device and accessories combinations is shown in FIG. 31B of one embodiment.

### Warranty Digital Device and Accessories Combinations:

FIG. 31B shows for illustrative purposes only an example of warranty digital device and accessories combinations of one embodiment. FIG. 31B shows a continuation of FIG. 31A showing warranty digital device and accessories combinations 3150. Warranty digital device and accessories combinations 3150 contain combination 1. Warranty and liquid glass coating 3160, combination 2. Warranty and screen protector 3161; combination 3. Warranty and screen protector and liquid glass coating 3162; combination 4. Warranty and digital device case and liquid glass coating 3163; combination 5. Warranty and digital device case and screen protector 3164; combination 6. Warranty and digital device case and screen protector and liquid glass coating 3165; combination 7. Warranty and digital device case 3166 of one embodiment.

The screen protector can be compromised of one type of screen protector from a group of screen protector types including but not limited to tempered glass, or bendable tempered glass, film, plastic, or a liquid glass coating. damage or phone device damage

### Examples of Digital Devices Eligible for Warranty Coverage:

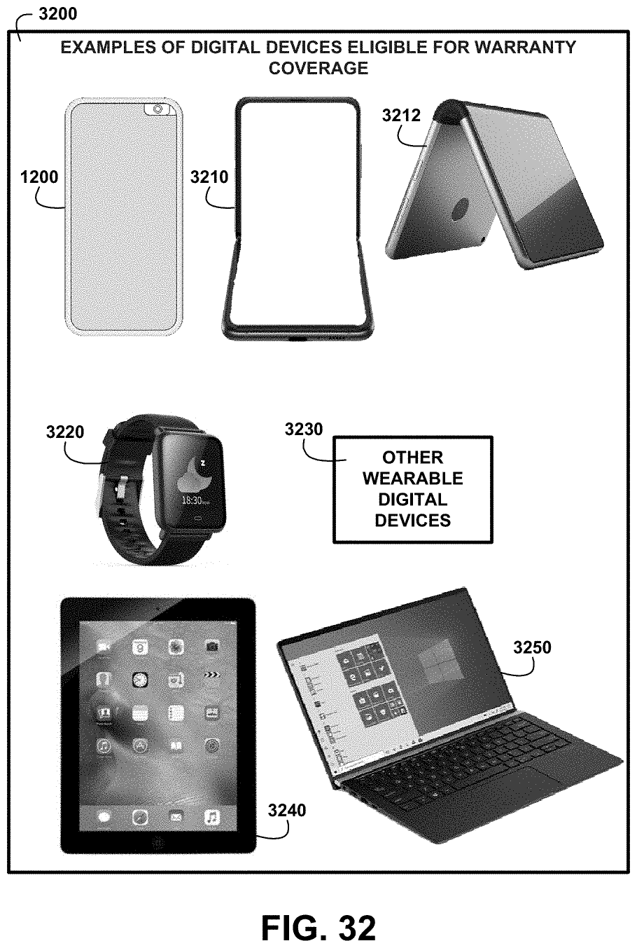

FIG. 32 shows for illustrative purposes only an example of examples of digital devices eligible for warranty coverage of one embodiment. FIG. 32 shows examples of digital devices eligible for warranty coverage 3200. The examples of digital devices eligible for warranty coverage 3200 contain digital devices from a group of cell phone 1200, top to bottom foldable phone 3210, side to side foldable phone 3212, wearable smart watch 3220, other wearable digital devices 3230, digital tablet 3240, and laptop computer 3250 of one embodiment. Eligibility for warranty coverage is applicable to other devices from a group of devices that can download and operate an application of one embodiment. A foldable phone case and/or a foldable phone may include a top to bottom, side to side and three-way foldable phone case, including a one part foldable phone case, a two-part foldable phone case and a three-part foldable phone case. A foldable phone case may be made of a flexible material, or a hard material, or a hybrid made with flexible and hard materials of one embodiment.

### Warranty Plan a Coverage:

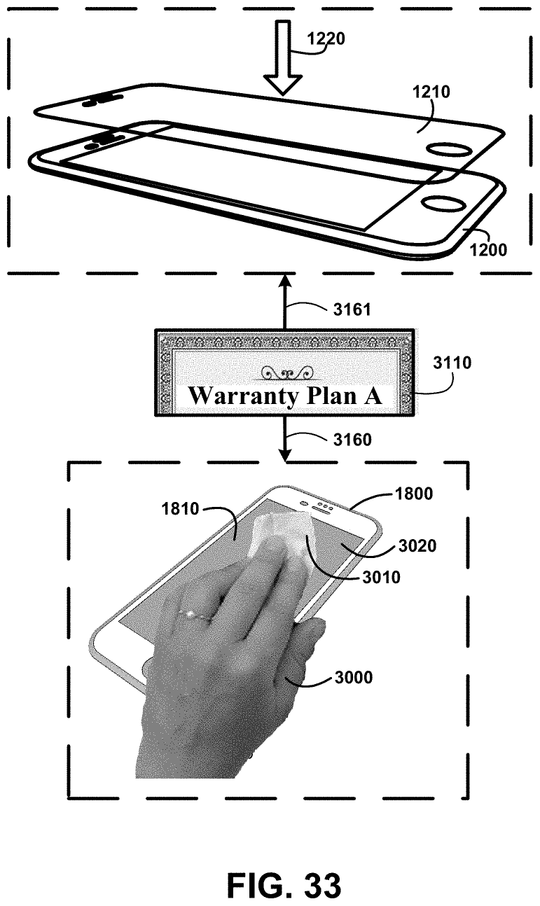

FIG. 33 shows for illustrative purposes only an example of Warranty Plan A coverage of one embodiment. FIG. 33 shows Warranty Plan A 3110 providing coverage in one embodiment for combination 2. Warranty and screen protector 3161. FIG. 33 shows the warranty purchaser cell phone 1200 and installing a tempered glass front cover on the surface of a cell phone 1220. A tempered glass front cover 1210 is one embodiment of a screen protector.

FIG. 33 shows Warranty Plan A 3110 providing coverage in one embodiment for combination 1. Warranty and liquid glass coating 3160. Shown is the digital device cell phone 1800 with the cell phone glass screen 1810. A user's hand 3000 is using the wipe material towelette 3010 to apply a liquid glass coating 3020 on the cell phone glass screen 1810. The liquid glass coating 3020 is the accessory for combination 1 of one embodiment.

### Warranty Plan B Coverage:

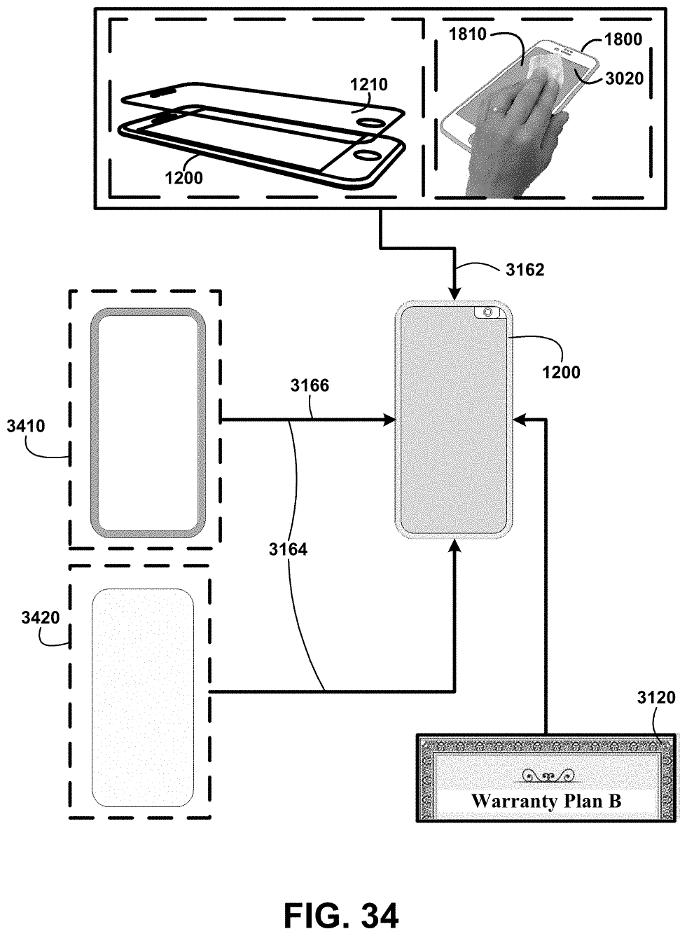

FIG. 34 shows for illustrative purposes only an example of Warranty Plan B coverage of one embodiment. FIG. 34 shows Warranty Plan B 3120 providing coverage for combination 3. Warranty and screen protector and liquid glass coating 3162. Combination 3 includes the warranty purchaser cell phone 1200 with the tempered glass front cover 1210 installing as one embodiment of a screen protector. The digital device cell phone 1800 and cell phone glass screen 1810 with a liquid glass coating 3020 being applied as one accessory of combination 3. Wherein FIG. 34 shows Warranty Plan B 3120 providing coverage for combination 3. Warranty and screen protector and liquid glass coating 3162.

A phone case 3410 is one embodiment of an accessory covered by Warranty Plan B 3120 in combination 7. Warranty and digital device case 3166. The phone case 3410 can include a screen protector 3420 for coverage of combination 5. Warranty and digital device case and screen protector 3164.

### Warranty Plan C Coverage:

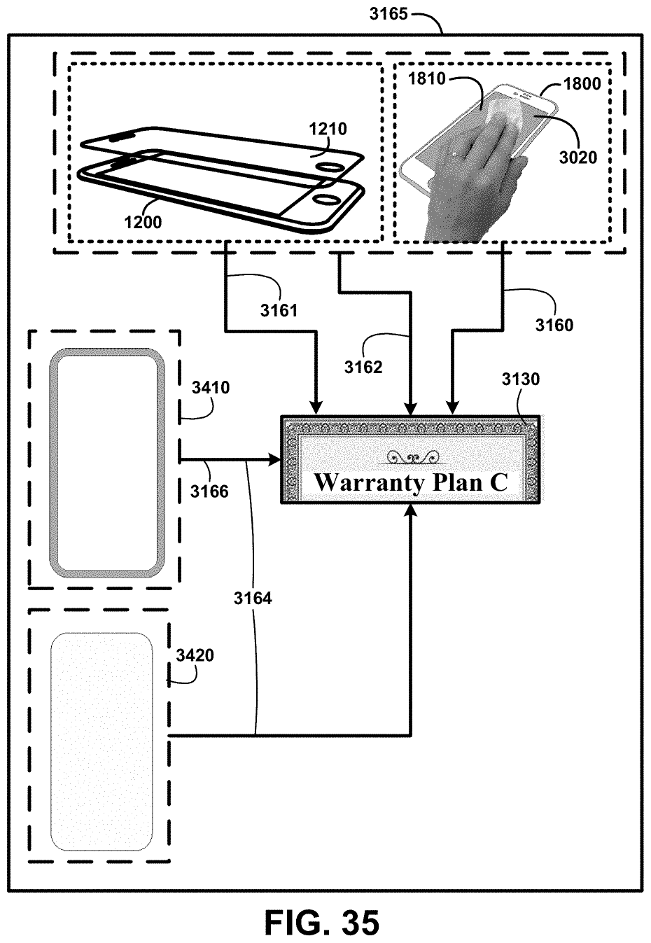

FIG. 35 shows for illustrative purposes only an example of Warranty Plan C coverage of one embodiment. FIG. 35 shows Warranty Plan C 3130 providing coverage for one or more of the accessories. Accessories include combination 2. Warranty and screen protector 3161 shown in one embodiment of a screen protector is the tempered glass front cover 1210 installed on the warranty purchaser cell phone 1200. Coverage is provided for combination 1. Warranty and liquid glass coating 3160. The liquid glass coating 3020 is applied on the cell phone glass screen 1810 of the digital device cell phone 1800. Warranty Plan C coverage also applies to combination 3. Warranty and screen protector and liquid glass coating 3162.

The phone case 3410 is covered in combination 7. Warranty and digital device case 3166 under Warranty Plan C. Coverage also extends to the screen protector 3420 coupled to the phone case 3410 under combination 5. Warranty and digital device case and screen protector 3164. All embodiments of the accessories apply to Warranty Plan C 3130 coverage under combination 6. Warranty and digital device case and screen protector and liquid glass coating 3165 of one embodiment.

### Warranty Plan D Coverage:

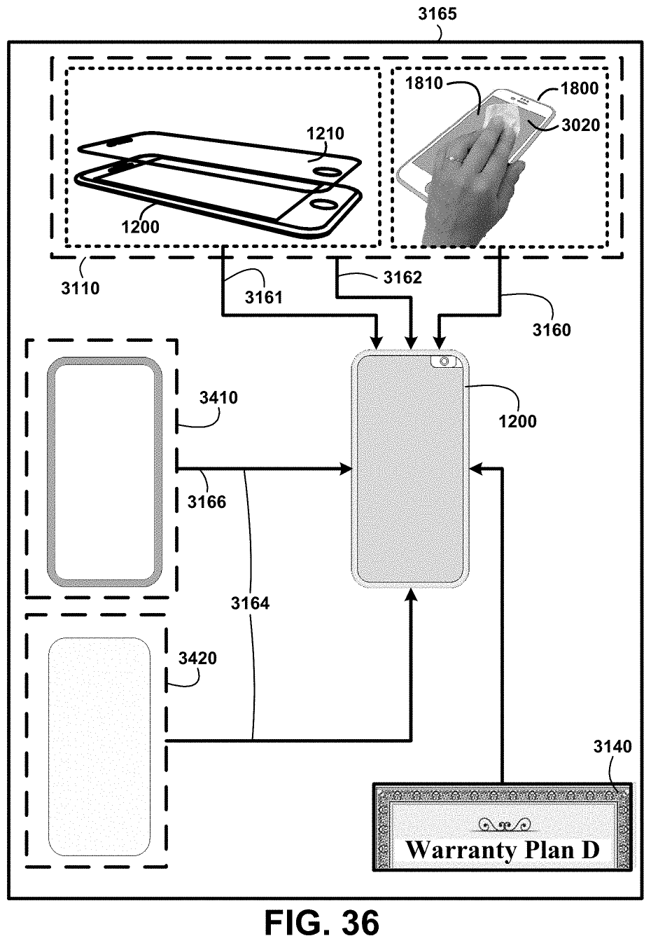

FIG. 36 shows for illustrative purposes only an example of Warranty Plan D coverage of one embodiment. FIG. 36 shows Warranty Plan D 3140 providing coverage for a totality of products. The totality of products contains a tempered glass front cover 1210 installed on a warranty purchaser cell phone 1200 wherein the tempered glass front cover 1210 is an embodiment of a screen protector under combination 2. Warranty and screen protector 3161. The totality of products also contains a liquid glass coating 3020 applied to the cell phone glass screen 1810 of a digital device cell phone 1800 under combination 1. Warranty and liquid glass coating 3160. These two accessories are covered under combination 3. Warranty and screen protector and liquid glass coating 3162.

The totality of products additionally contains the phone case 3410 of combination 7. Warranty and digital device case 3166. A screen protector 3420 coupled to the phone case 3410 is covered in combination 5. Warranty and digital device case and screen protector 3164. All of the previous accessories are covered under combination 6. Warranty and digital device case and screen protector and liquid glass coating 3165. The totality of products further contains the components of the warranty purchaser cell phone 1200 with Warranty Plan D 3140 of one embodiment.

Digital Device Warranty Purchaser Registering their Identification Information Input:

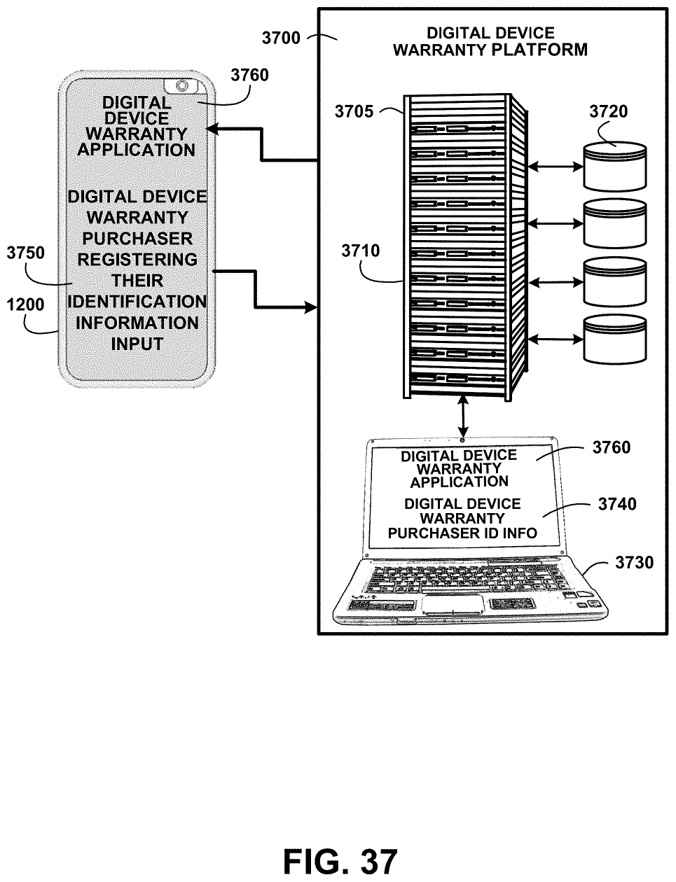

FIG. 37 shows for illustrative purposes only an example of digital device warranty purchaser registering their identification information input of one embodiment. FIG. 37 shows the warranty purchaser cell phone 1200 with a digital device warranty application 3760 downloaded from the digital device warranty platform computer 3730. The digital device warranty application 3760 is one method for a digital device warranty purchaser registering their identification information input 3750. The digital device warranty application 3760 transmits to the digital device warranty platform 3700 the digital device warranty purchaser ID info 3740 on a digital device warranty platform website portal 3705. The digital device warranty platform 3700 includes at least one digital server 3710, a plurality of databases 3720 and a digital device warranty platform computer 3730 with the digital device warranty application 3760.

The warranty purchaser will register the purchaser's identification information input 3750. The purchaser's identification information input 3740 can include at least a single piece of information including but not limited to; the name, last name, address, phone number of the purchaser; the serial number of the phone case or the phone, or the screen protector; the serial number or IMEI (International Mobile Equipment Identity) number of a device/phone; an image of the purchaser's driver's license, passport or ID; one or more images or video of the purchaser's phone or device; invoice or receipt of purchase; adding/uploading a photo or video of the phone screen during application for registering the phone for which the warranty is being purchased as an owner's verification information. The purchaser may submit the warranty registration application using software or digital device warranty application 3760 downloaded on purchaser's phone 1200 or computer of one embodiment.

In another embodiment the warranty purchaser may register using a social media website or application to the warranty plan digital device warranty platform 3700. In yet another embodiment the purchaser's identification information input 3740 can be registered through a digital device warranty platform website portal 3705 of one embodiment. A warranty purchaser login to the digital device warranty platform 3200 website portal may include using a fingerprint feature of the purchaser's phone.

A warranty purchaser login to the digital device warranty platform 3700 website portal may include using a fingerprint feature of the purchaser's phone. The purchaser may submit a photo or video of the purchaser's phone screen with the registration. This photo and/or video can be compared to a photo of damage or phone device damage of one embodiment.

### Digital Device Warranty Purchaser Filing a Damage Claim:

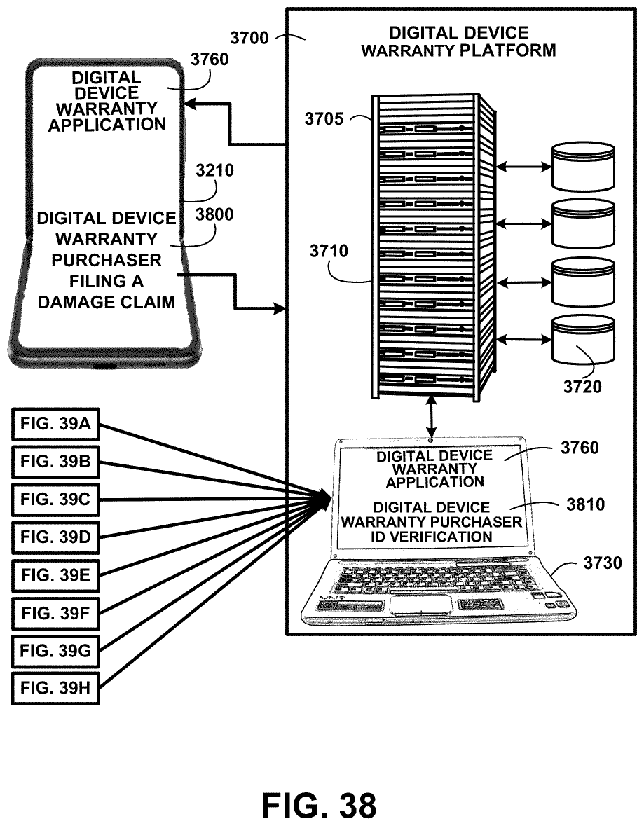

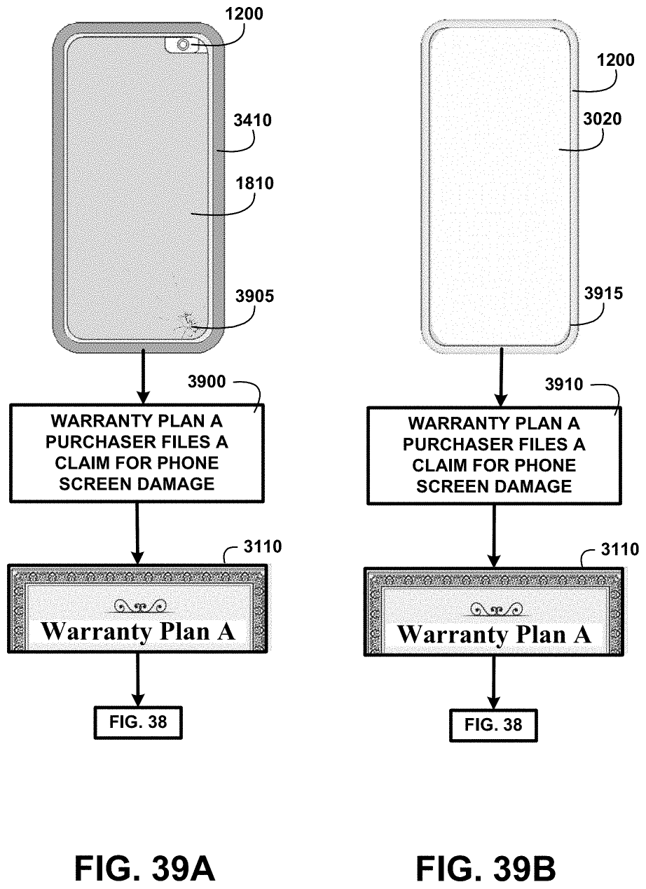

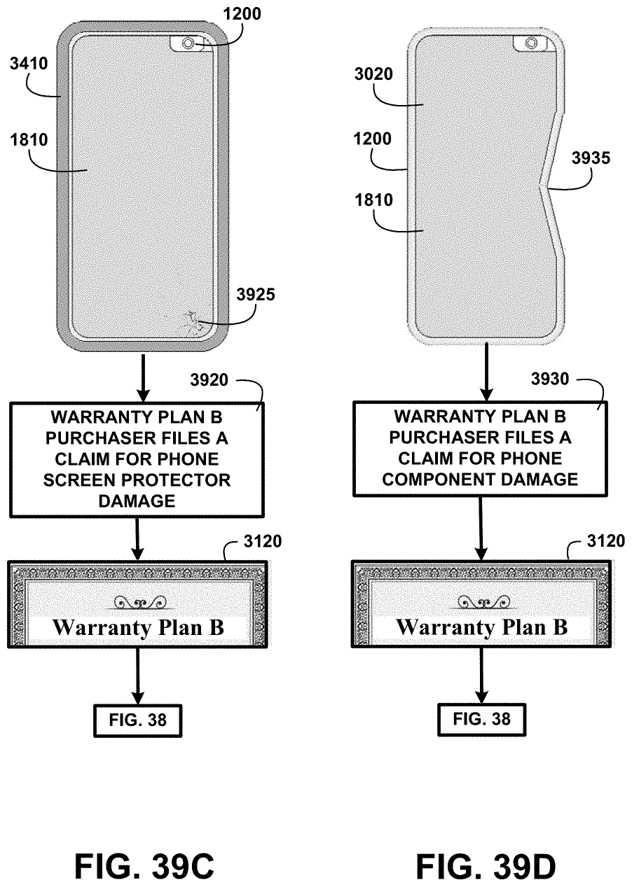

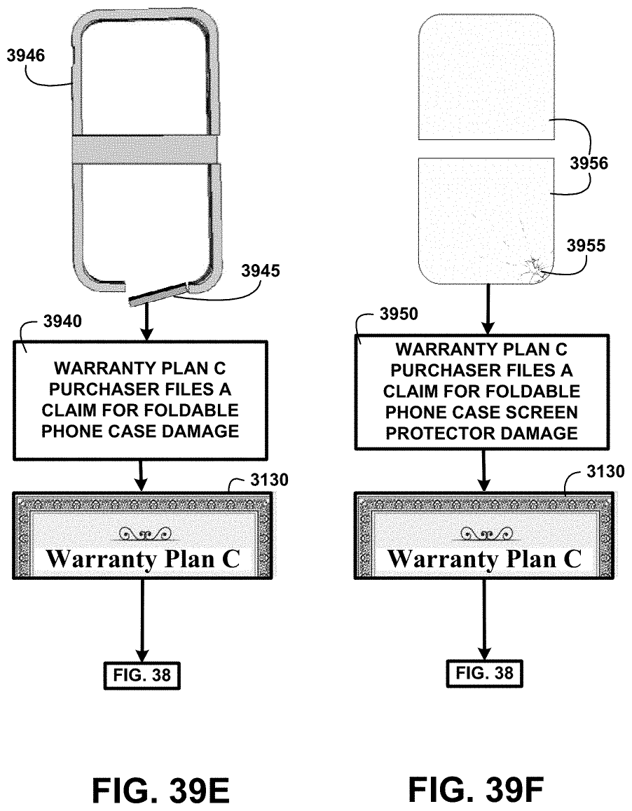

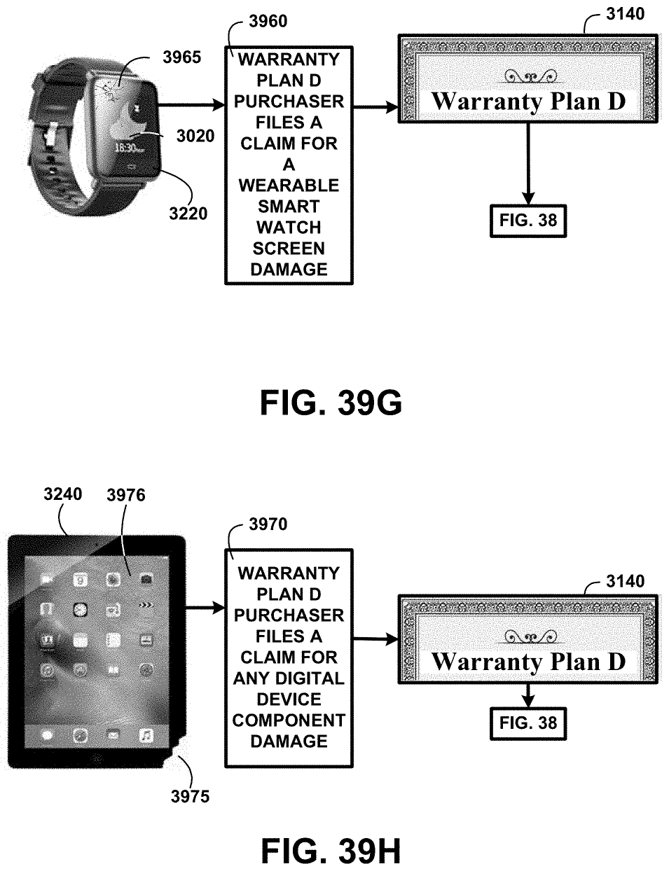

FIG. 38 shows for illustrative purposes only an example of digital device warranty purchaser filing a damage claim of one embodiment. FIG. 38 shows the top to bottom foldable phone 3210 with the digital device warranty application 3760. A warranty purchaser login to the digital device warranty platform 3200 website portal will process a digital device warranty purchaser ID verification 3810 for the digital device warranty purchaser filing a damage claim 3800. The digital device warranty purchaser damage claim is transmitted to the digital device warranty platform computer 3760 then transmitted to the digital device warranty platform 3700. The digital device warranty platform 3700 includes the digital device warranty platform website portal 3705, at least one digital server 3710, a plurality of databases 3720, digital device warranty platform computer 3730 with the digital device warranty application 3760. The digital device warranty platform 3700 will process claims from FIG. 39A, FIG. 39B, FIG. 39C, FIG. 39D, FIG. 39E, FIG. 39F, FIG. 39G and FIG. 39H of one embodiment.

### A Warranty Plan a First Damage Claim:

FIG. 39A shows for illustrative purposes only an example of a Warranty Plan A first damage claim of one embodiment. FIG. 39A shows the warranty purchaser cell phone 1200 and cell phone glass screen 1810. A phone case 3410 is coupled to the warranty purchaser cell phone 1200. Also showing is cell phone glass screen crack damage 3905. The Warranty Plan A purchaser files a first damage claim for phone screen damage 3900 with coverage from Warranty A 3110. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan a Second Damage Claim:

FIG. 39B shows for illustrative purposes only an example of a Warranty Plan A second damage claim of one embodiment. FIG. 39B shows the warranty purchaser cell phone 1200 with the liquid glass coating 3020. Also showing is phone screen and liquid glass coating damage 3915. The Warranty Plan A purchaser files a claim for phone screen damage 3910 with coverage from Warranty Plan A 3110. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan B First Damage Claim:

FIG. 39C shows for illustrative purposes only an example of a Warranty Plan B first damage claim of one embodiment. FIG. 39C shows the warranty purchaser cell phone 1200 and cell phone glass screen 1810 with the phone case 3410 coupled to the cell phone 1200. Also showing is cell phone glass screen crack damage 3925. The Warranty Plan B purchaser files a claim for phone screen damage 3920 with coverage from Warranty Plan B 3120. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan B Second Damage Claim:

FIG. 39D shows for illustrative purposes only an example of a Warranty Plan B second damage claim of one embodiment. FIG. 39D shows the warranty purchaser cell phone 1200 and cell phone glass screen 1810 with the liquid glass coating 3020. Also showing is warranty purchaser cell phone damage 3935. The Warranty Plan B purchaser files a claim for phone component damage 3930 with coverage from Warranty Plan B 3120. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan C First Damage Claim:

FIG. 39E shows for illustrative purposes only an example of a Warranty Plan C first damage claim of one embodiment. FIG. 39E shows a top to bottom foldable phone case 3946 with top to bottom foldable phone case damage 3945. The Warranty Plan C purchaser files a claim for foldable phone case damage 3940 with coverage from Warranty Plan C 3130. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan C Second Damage Claim:

FIG. 39F shows for illustrative purposes only an example of a Warranty Plan C second damage claim of one embodiment. FIG. 39F shows foldable phone case screen protectors 3956 with foldable phone case screen protector damage 3955 to one part. The Warranty Plan C purchaser files a claim for foldable phone case screen protector damage 3950 with coverage from Warranty Plan C 3130. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan D First Damage Claim:

FIG. 39G shows for illustrative purposes only an example of a Warranty Plan D first damage claim of one embodiment. FIG. 39G shows the warranty purchaser's wearable smart watch 3220 with the liquid glass coating 3020 on the wearable smart watch 3220 screen. Also showing is wearable smart watch screen damage 3965. The Warranty Plan D purchaser files a claim for a wearable smart watch screen damage 3960 with coverage from Warranty Plan D 3140. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

### A Warranty Plan D Second Damage Claim:

FIG. 39H shows for illustrative purposes only an example of a Warranty Plan D second damage claim of one embodiment. FIG. 39H shows the warranty purchaser's digital tablet 3240 with a digital tablet tempered glass screen protector 3976. Also showing is digital tablet damage 3975. The Warranty Plan D purchaser files a claim for any digital device component damage 3970 with coverage from Warranty Plan D 3140. The claim is processed as described in FIG. 38 of one embodiment.

The warranty purchaser's damage reporting may include reporting the damage claim through the digital device warranty application 3760. In another embodiment the warranty purchaser may report the damage claim using the digital device warranty platform website portal 3705 with a digital device or a social media website or application to the warranty plan digital device warranty platform 3700 of one embodiment. The purchaser may submit a photo or video of the purchaser's phone case screen protector damage or phone device damage. This photo and video can be compared to a photo submitted with the registration of one embodiment.

Phone Case with an Array of LED Lights:

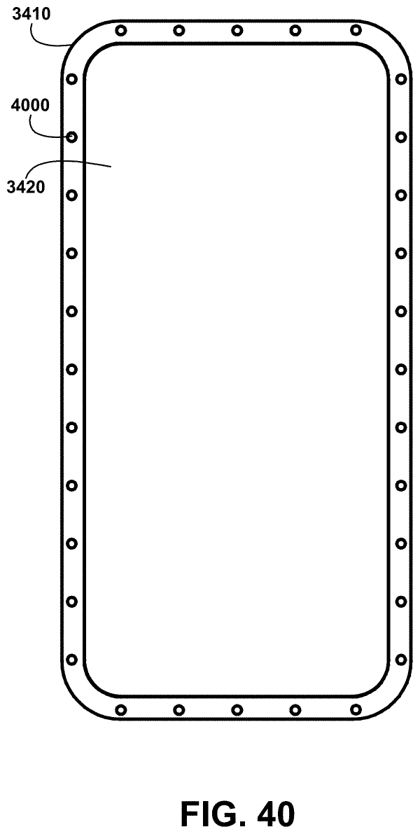

FIG. 40 shows for illustrative purposes only an example of a phone case with an array of LED lights of one embodiment. FIG. 40 shows a phone case 3410 with a screen protector 3420 coupled with an array of LED lights 4000. The LED lights 4000 may be arranged around the perimeter of the phone case 3410. In one embodiment the array of LED lights 4000 may function for aesthetic purposes. In another embodiment the array of LED lights 4000 may function for photograph/video lighting purposes. The array of LED lights 4000 may be configured as clear lens lights or colored lens lights of one embodiment. In another embodiment strip lights are coupled to the phone case perimeter. The coupled strip lights may be configured to function for aesthetic purposes. In other embodiments the coupled strip lights may be configured to function for photograph/video lighting purposes. In yet another embodiment the user may regulate the light intensity of the coupled strip lights configured to incorporate multiple lighting levels of one embodiment.

The foregoing has described the principles, embodiments and modes of operation of the embodiments. However, the embodiments should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
creating at least one warranty plan for financially protecting a phone or any digital device owner from damage of a phone case, screen protector, phone screen protector and a phone device or any digital device for any components damaged;
providing warranty coverage for different types of phone cases including non-foldable and foldable phone cases;
providing warranty coverage for different types of phone case screen protectors;
providing warranty coverage for different types of phone or digital device components;
registering warranty purchasers identification information is performed on a digital device warranty platform using a digital device internet connection to a digital device warranty platform website portal;
receiving warranty claims filed by warranty purchasers using the digital device warranty platform website portal; and
recording and processing warranty claims filed by warranty purchasers on the digital device warranty platform.

2. The method of claim 1, further comprising creating a warranty protection plan for a phone case screen protector made from a selected material from a group of materials including tempered glass, bendable tempered glass, plastic, bendable plastic, a liquid glass coating applied to a phone screen.

3. The method of claim 1, further comprising creating a warranty protection plan for a phone case made a selected material from a group of materials including a flexible material, a hard material and a hybrid of flexible and hard materials.

4. The method of claim 1, further comprising creating a warranty protection plan for a foldable phone case including one from a group of a top to bottom, side to side and three-way foldable phone case.

5. The method of claim 1, further comprising creating a warranty protection plan for a foldable phone case including one from a group of a one part foldable phone case, a two-part foldable phone case and a three-part foldable phone case.

6. The method of claim 1, further comprising registering a digital device warranty plan inputting a purchaser identification information input using a social media website to the digital device warranty platform.

7. The method of claim 1, further comprising logging into the digital device warranty platform using a fingerprint feature of the owner's phone for identification for filing a claim.

8. The method of claim 1, further comprising filing a claim with the digital device warranty plan using a social media website to the digital device warranty platform.

9. The method of claim 1, further comprising using a plurality of databases for recording digital device warranty registrations.

10. The method of claim 1, further comprising using a plurality of databases for recording digital device warranty claims.

11. An apparatus, comprising:
a digital device warranty platform for processing digital device warranty registrations and claims configured with a website portal;
at least one digital server for connectivity between the digital device warranty platform elements;
a plurality of digital device warranty databases for recording digital device warranty registrations and claims;
a digital device warranty platform computer for connectivity to digital device warranty platform elements; and
a digital device warranty application for sending and receiving owner communications and transmitting information to digital device warranty platform elements.

12. The apparatus of claim 11, wherein the digital device warranty application may be installed on a digital device warranty owner's phone for registration of the owner purchaser identification information input.

13. The apparatus of claim 11, wherein the digital device warranty platform computer transmits the digital device warranty purchaser ID and phone info to the plurality of digital device warranty databases.

14. The apparatus of claim 11, wherein the plurality of digital device warranty databases are segregated for digital device warranty A and digital device warranty B registrations and claims.

15. The apparatus of claim 11, wherein the digital device warranty platform computer is configured to receive a phone case purchased owner registration and claims from the owner via a social media website.

16. An apparatus, comprising:
an apparatus for registering purchasers of at least one warranty plan for financially protecting a digital phone owner from damage of a phone case, screen protector, and phone device components;
an apparatus for receiving damage claims for the at least one warranty plan coverage for different types of phone cases including non-foldable and foldable phone cases;
an apparatus for receiving damage claims for the at least one warranty plan coverage for different types of screen protectors; and
an apparatus for receiving damage claims for the at least one warranty plan coverage for different types of phone device components.

17. The apparatus of claim 16, wherein the apparatus is configured for registering purchasers of at least one warranty plan wherein purchaser's identification information input is received from a purchaser's digital device and recorded in a plurality of databases.

18. The apparatus of claim 16, wherein the apparatus for registering purchasers of at least one warranty plan is configured for receiving purchaser's identification information input for registration from a purchaser on a social media website.

19. The apparatus of claim 16, wherein the apparatus for receiving damage claims for the at least one warranty plan coverage is configured to receive such damage claims from a registered purchaser using a digital device warranty application.

20. The apparatus of claim 16, wherein the apparatus for receiving damage claims for the at least one warranty plan coverage is configured to receive such damage claims from a registered purchaser's digital device and recorded in a plurality of databases.
